(19) United States
(12) Patent Application Publication
(10) Pub. No.: US 2026/0289171 A1
(43) Pub. Date: Sep. 24, 2026

(54) SYSTEM

(71) Applicant: SoftBank Group Corp., Tokyo (JP)

(72) Inventor: Emi FUJITA, Tokyo (JP)

(73) Assignee: SoftBank Group Corp., Tokyo (JP)

(21) Appl. No.: 19/564,312

(22) Filed: Mar. 12, 2026

(30) Foreign Application Priority Data
Mar. 19, 2025 (JP) 2025-045008

(51) Int. Cl. G06F 40/40; G06F 40/205; G06N 3/0475

(52) U.S. Cl. CPC G06F 40/40; G06F 40/205; G06N 3/0475

(57) ABSTRACT

A system includes a processor that is configured to record, in a database, information on places that a user desires to visit, synchronize with a calendar application to acquire schedule information of the user, acquire weather information and congestion information, generate a prompt for instructing a generative AI model to propose one or more places to be visited, input the prompt to the generative AI model, obtain an evaluation by the user regarding a proposed place, and retrain the generative AI model based on the evaluation in order to improve a subsequent proposal.

### CROSS-REFERENCE TO RELATED APPLICATION

This application is based on and claims priority under 35 USC 119 from Japanese Patent Application No. 2025-045008 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional travel and outing recommendation systems generally rely on static rule-based algorithms or simple scoring functions that do not fully exploit dynamic external information such as up-to-date weather conditions and congestion levels. Such systems also tend to treat user feedback in a limited way, for example by merely adjusting recommendation scores, and therefore fail to continuously improve the quality and personalization of visit proposals for individual users. In addition, known systems are not designed to systematically construct and provide optimal prompts to generative AI models, and thus cannot effectively leverage the generative AI models'capability to create flexible and context-aware visit plans. Furthermore, there is no unified framework that: (i) acquires “places the user desires to visit” from external information sharing platforms, (ii) integrates calendar-based schedule information, weather information, and congestion information, and (iii) cyclically updates a generative AI model based on explicit user evaluations of proposed places. Accordingly, there is a need for a system that can automatically collect the relevant information, generate appropriate prompts for a generative AI model, provide accurate and personalized visit proposals, and improve subsequent proposals through retraining of the generative AI model based on user evaluations.

### SUMMARY

In order to solve the above-described problems, according to one embodiment, a system is provided that comprises a processor configured to record, in a database, information on places that a user desires to visit, to synchronize with a calendar application to acquire schedule information of the user, and to acquire weather information and congestion information. The processor is further configured to generate a prompt for instructing a generative AI model to propose one or more places to be visited, to input the prompt to the generative AI model, to obtain an evaluation by the user regarding a proposed place, and to retrain the generative AI model based on the evaluation in order to improve a subsequent proposal. The processor may be configured to acquire the information on the places that the user desires to visit via an API of an information sharing platform and to store the information in the database. The processor may also be configured to integrate the schedule information of the user, the weather information, and the congestion information, to generate a prompt for instructing the generative AI model to generate an optimal visit plan based on the integrated information, and to input the prompt to the generative AI model. By such configuration, the system automatically aggregates external and internal information relevant to the user's potential visits, formulates this information into a structured prompt for the generative AI model, and performs iterative improvement of the model using user evaluations, thereby achieving more accurate and personalized visit proposals.

The term “system” refers to a combination of hardware and software components including at least one processor and one or more storage devices that cooperate to perform the functions recited in the claims.

The term “processor” refers to any hardware logic element or combination of hardware logic elements, such as a central processing unit (CPU), a microprocessor, a microcontroller, a digital signal processor, or a programmable logic device, that executes instructions to perform operations specified in the claims.

The term “database” refers to any structured data storage facility, including relational databases, NoSQL databases, key-value stores, or other persistent storage systems, that is configured to store and manage information on places and other data related to the claimed system.

The term “information on places that a user desires to visit” refers to data representing locations that a user has indicated an interest in visiting, including at least a place name or identifier, and optionally including address information, geographic coordinates, category information, user identifiers, and timestamps.

The term “calendar application” refers to any software application or service that manages scheduling information, including, for example, digital calendars accessible via a network or locally on a device, and that provides an interface or API for reading and optionally writing schedule entries.

The term “schedule information of the user” refers to data representing events, appointments, free time slots, or other temporal information associated with the user and managed by a calendar application.

The term “weather information” refers to data relating to meteorological conditions, including, for example, temperature, precipitation, cloud cover, and weather forecasts for specific times and locations.

The term “congestion information” refers to data representing a degree of crowding or usage level at a place, including, for example, historical or predicted numbers of visitors, density levels, congestion categories, or similar indicators for specific times.

The term “generative AI model” refers to a machine learning model, such as a large language model, a generative neural network, or other generative artificial intelligence model, that is capable of generating outputs, including textual proposals for places to visit or visit plans, in response to input prompts.

The term “prompt” refers to input data, typically textual data, that encodes instructions, constraints, and context information and that is provided to a generative AI model to cause the generative AI model to generate a desired output, such as proposals for places to visit or visit plans.

The term “information sharing platform” refers to a service or system, including, for example, a social media platform or a user-generated content platform, through which users can share, mark, or store information about places or activities.

The term “API of an information sharing platform” refers to an application programming interface provided by the information sharing platform that enables programmatic access to user-related data, including data indicating places that a user desires to visit.

The term “optimal visit plan” refers to a proposed arrangement including at least a place to visit and a time or time interval for the visit, which is determined based on one or more criteria such as the user's schedule information, weather information, and congestion information, and which is intended to be favorable or preferred for the user.

The term “evaluation by the user” refers to feedback information explicitly provided by the user regarding a proposed place or visit plan, including, for example, ratings, qualitative comments, or indications of satisfaction or dissatisfaction.

The term “retrain the generative AI model” refers to a process of updating parameters of the generative AI model, or fine-tuning the generative AI model, using additional training data derived from user evaluations or related information, so as to modify subsequent outputs of the generative AI model.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

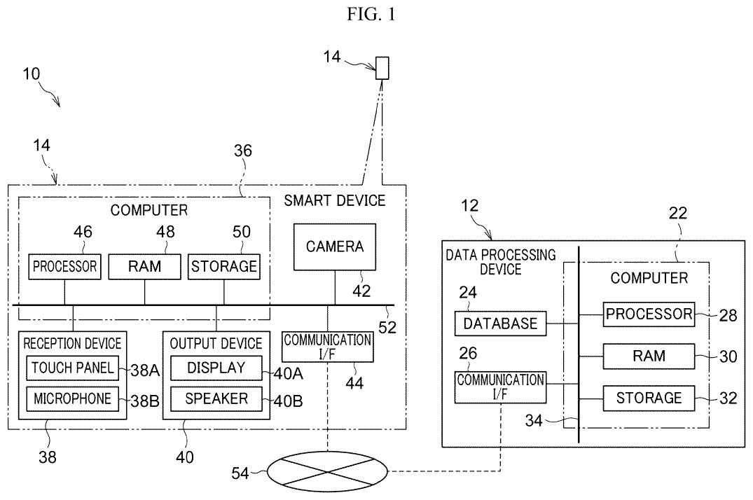

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

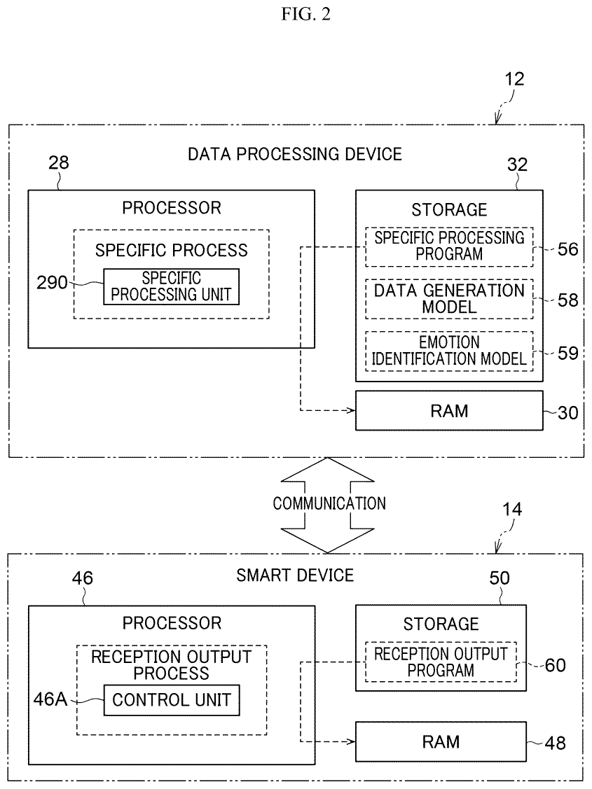

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented travel recommendation systems typically rely on static rules or simple heuristic scoring that separately considers user-preferred locations, calendar availability, weather forecasts, or congestion indicators. Such systems often suffer from several technical shortcomings.

First, conventional systems generally retrieve and process external data sources, such as calendar data, weather data, and congestion data, in a siloed manner. The systems frequently lack an integrated data model that associates each candidate location with specific user-available time slots, corresponding weather conditions, and congestion levels. As a result, the systems are unable to compute, at scale, accurate evaluation values for each combination of location and time slot, thereby limiting the precision and responsiveness of the recommendation engine.

Second, conventional systems typically generate fixed-format recommendation messages or user interface text directly from procedural logic. These messages are not adaptively generated from structured context data, and the systems do not exploit generative information processing apparatuses in a systematic way. Even where a generative information processing apparatus is used, the construction of prompt sentences is ad hoc and not tightly coupled to the underlying structured data model. This leads to inefficiencies in how the recommendation context is encoded for the generative model, and degrades the quality, specificity, and consistency of the natural-language recommendations that are ultimately presented to the user.

Third, known systems often treat user feedback as an auxiliary, non-structured signal, for example by recording only coarse ratings or unstructured comments without integrating them into the core scoring mechanism. Consequently, the systems do not establish a feedback loop that automatically updates weighting coefficients or evaluation parameters in response to user satisfaction captured under different contextual conditions, such as particular weather states, congestion levels, or time-of-day attributes. This lack of structured feedback integration prevents the recommendation algorithm from being personalized and tuned for individual users over time.

Fourth, the absence of a systematic association between user feedback and contextual attributes results in inefficient utilization of computing resources. The recommendation engine repeatedly performs similar computations without leveraging accumulated evaluation information to refine the scoring function. This can lead to unnecessary calls to external services, redundant recomputation of low-quality candidate plans, and increased latency in generating useful recommendations, all of which reduce the overall efficiency of the computer system.

Accordingly, there is a need for a computer-implemented technique that (i) integrates user-desired locations, user time availability, weather information, and congestion information into a unified data structure at the level of individual location-time combinations; (ii) generates structured prompts for a generative information processing apparatus based on such integrated data; and (iii) systematically incorporates user evaluation information into the scoring algorithm as updated weighting coefficients or evaluation parameters. By addressing these issues, the present invention aims to improve the operation of the computer system itself, including more efficient data processing, more effective use of external information sources and generative models, and technically improved, adaptive selection of visit candidates tailored to an individual user.

The specific processing by the specific processing unit 290 of the data processing device 12 in Example 1 is realized by the following means.

The present invention provides a server comprising a processor and a storage device, the processor being configured to acquire information indicating locations that a user desires to visit and store the information in the storage device; to acquire time-availability information of the user by cooperating with a schedule-management application, to extract time slots during which the user is available, and to store the extracted time slots in the storage device; to acquire, from an external information providing device, weather information and congestion information corresponding to combinations of the locations that the user desires to visit and the time slots during which the user is available, and to store the acquired weather information and congestion information in the storage device in association with the combinations; to calculate, based on information stored in the storage device including the locations, the time slots, the weather information, and the congestion information, an evaluation value for each combination of a location and a time slot, and to select visit candidates based on the calculated evaluation values; to generate a prompt sentence by converting structured data that includes the selected visit candidates and reasons for selection into a description format that causes a generative information processing apparatus to generate a natural-language recommendation sentence explaining or recommending the visit candidates, and to input the prompt sentence to the generative information processing apparatus; to present, via an output device, the recommendation sentence output from the generative information processing apparatus, to acquire evaluation information of the user regarding the presented recommendation sentence and the visit candidates, and to store the acquired evaluation information in the storage device; and to analyze the acquired evaluation information in association with the weather information, the congestion information, the time slots, and attribute information regarding the locations, and to update weighting coefficients or evaluation parameters used when calculating the evaluation values, thereby adjusting selection processing of visit candidates for subsequent proposals to be adapted to the individual user. This enables the computer system to implement an integrated, context-aware recommendation pipeline wherein data from heterogeneous sources is normalized and associated at the level of specific location-time combinations, prompts for a generative information processing apparatus are systematically constructed from the structured context, and user feedback is fed back into the scoring logic as updated weighting coefficients or evaluation parameters, thereby improving the technical performance of the system in terms of recommendation accuracy, personalization, computational efficiency, and effective utilization of generative models.

The term “location that a user desires to visit” refers to a physical point of interest, such as a facility, site, or area, that is indicated by the user as a desired destination and that can be identified by at least position information, an identifier, or descriptive data.

The term “storage device” refers to a hardware or virtual component, such as a memory, disk device, or database system, that is configured to store and retain data used or generated by the processor.

The term “time-availability information” refers to data indicating time intervals during which the user is available for visiting a location, the data being derived from schedule information or calendar records associated with the user.

The term “schedule-management application” refers to a software component or service configured to manage time-based records for the user, such as events, appointments, or tasks, and to provide access to such data via an interface.

The term “time slot” refers to a time interval represented by at least a start time and an end time, and during which the user is determined to be available for visiting a location.

The term “external information providing device” refers to a computing system or service, separate from the server, that supplies data such as weather information or congestion information via a communication interface.

The term “weather information” refers to data representing atmospheric conditions associated with at least one location and time, including but not limited to condition type, temperature, precipitation, or similar weather-related attributes.

The term “congestion information” refers to data representing a degree of occupancy, crowding, or usage level associated with at least one location and time, including quantitative scores or qualitative labels indicating how busy the location is.

The term “combination of a location and a time slot” refers to an association between a particular location that the user desires to visit and a particular time interval during which the user is available.

The term “evaluation value” refers to a numerical or ordered metric calculated by the processor for each combination of a location and a time slot, the metric indicating a relative suitability or desirability of the combination as a visit candidate.

The term “visit candidate” refers to a specific proposal of a location and a time slot for the user to visit, selected based on evaluation values or similar scoring criteria.

The term “structured data” refers to information that is organized in a predefined format, such as key-value pairs, tables, or records, enabling deterministic parsing and processing by the processor and by other components.

The term “selection reason” refers to information that explains or justifies why a particular combination of a location and a time slot has been selected as a visit candidate, the information being derived from evaluation values or underlying contextual data.

The term “prompt sentence” refers to a natural-language or semi-structured expression generated by the processor, and provided as input to a generative information processing apparatus to cause the apparatus to output a corresponding natural-language result.

The term “generative information processing apparatus” refers to a computing apparatus, such as a generative artificial intelligence model or language model, which is configured to generate text or other information based on an input prompt.

The term “recommendation sentence” refers to a sequence of natural-language expressions generated by the generative information processing apparatus, which explains or recommends one or more visit candidates to the user.

The term “output device” refers to a hardware or logical component, such as a display, speaker, or client terminal interface, configured to present information, including recommendation sentences, to the user.

The term “evaluation information” refers to data representing the user's response to or appraisal of one or more visit candidates or recommendation sentences, including, for example, rating values, selection actions, or comment data.

The term “attribute information regarding the locations” refers to descriptive data related to each location, such as category, type, accessibility, typical visit duration, or any other feature useful for evaluating or characterizing the location.

The term “weighting coefficient” refers to a parameter value used by the processor to scale or adjust contributions of different factors, such as weather conditions or congestion levels, when calculating evaluation values.

The term “evaluation parameter” refers to a configurable parameter other than a weighting coefficient that influences how evaluation values are calculated, including thresholds, bias terms, or rule parameters.

In one embodiment, a server cooperates with a terminal operated by a user to implement a visit-planning system that integrates user-desired locations, user time availability, weather information, congestion information, and a generative AI model. The server executes one or more programs stored in a storage device. The programs are executed by a processor such as a multi-core CPU or a CPU in combination with a GPU. The storage device includes, for example, main memory, a non-transitory storage medium such as a solid-state drive, and a database management system.

The server uses a relational database management system, such as a general-purpose SQL-based database, to store structured records for users, locations, time slots, weather attributes, congestion attributes, evaluation values, feedback entries, and configuration parameters including weighting coefficients. The server maintains, in the database, a normalized schema in which each record corresponding to a combination of a location and a time slot includes foreign keys to a user table, a location table, and a time-slot table, as well as fields storing weather attributes, congestion attributes, and a computed evaluation value.

The terminal is, for example, a smartphone, tablet, or personal computer. The terminal runs a client-side application or a web browser that communicates with the server via a communication network using a protocol such as HTTPS. The terminal includes a display unit, an input interface such as a touchscreen or keyboard, and a local storage component.

The user operates the terminal to register locations that the user desires to visit, to permit access to calendar data, to confirm recommendation sentences, and to provide evaluation information.

The server uses a web application framework, such as a general-purpose server framework, to implement a network API. The processor of the server executes program modules including a location-management module, a schedule-integration module, an external-data-acquisition module, an evaluation-computation module, a generative-AI-integration module, and a feedback-learning module. Each module is implemented as server-side software components that exchange data through defined interfaces and shared database tables.

The server acquires information indicating locations that the user desires to visit by receiving, from the terminal, data obtained through an information-sharing service API. The terminal calls an information-sharing service API provided by an information-sharing platform and receives, for example, a list of identifiers and metadata for content items where the user has marked a location as “want to visit.” The terminal converts these items into a normalized payload including at least a location name, latitude, longitude, and platform-specific identifier, and transmits the payload to the server. The server stores the location data in the location table, and associates it with the user through a mapping table.

The server acquires time-availability information of the user by integrating calendar data from an external schedule-management application. The terminal initiates an authentication flow with a calendar provider and obtains an access token. The terminal then sends the token or derived availability data to the server. In one embodiment, the server itself calls a calendar API, such as a general calendar free/busy API, using the token to retrieve time intervals during which the user is busy. The server processes the retrieved event data and derives time slots during which the user is available. The server stores each time slot in a time-slot table with fields including user identifier, start time, end time, and optional attributes such as day-of-week and time-of-day category.

The server acquires weather information corresponding to combinations of locations and time slots by querying an external weather service. For each location and time slot, the server constructs a request specifying geographic coordinates and a forecast time. The server calls a weather-information API provided by a weather information service over HTTPS using an HTTP client library. The server receives, for each request, structured weather data including values such as temperature, precipitation probability, humidity, and a weather condition code.

The server converts these values into a set of normalized features, such as a binary indicator for rain, a scalar comfort index derived from temperature and humidity, and a categorical code for the general condition type. The server stores these features in a weather-attribute table keyed by a combination identifier or a composite key of location identifier and time-slot identifier.

The server acquires congestion information corresponding to combinations of locations and time slots by querying an external traffic or crowding-information service. For each location and time slot, the server calls an external API that provides crowd-level or occupancy metrics based on historical and real-time traffic data. The server receives, for example, a normalized congestion score between 0 and 1, or qualitative labels such as “low,” “medium,” or “high.”

The server converts qualitative labels to numerical scores by a mapping table, and optionally aggregates historical congestion data to obtain predicted crowd levels at the planned visit time. The server stores the resulting congestion attributes in a congestion-attribute table.

The server computes evaluation values for each combination of a location and a time slot by executing the evaluation-computation module. The evaluation-computation module uses a parameterized scoring function that combines multiple features: a baseline preference level for the location, a weather score derived from weather attributes, a congestion score derived from congestion attributes, and additional contextual features such as time-of-day category and day-of-week. The processor applies a linear or non-linear combination function of the form:
score=w_loc×f_loc+w_weather×f_weather+w_cong×f_cong+w_time×f_time+b where f_loc, f_weather, f_cong, and f_time are feature values, w_loc, w_weather, w_cong, and w_time are weighting coefficients, and b is a bias parameter. The server stores the resulting evaluation value in a combination table.

In one embodiment, the server implements the scoring function using a multi-layer neural network. The neural network includes an input layer that receives a feature vector constructed from location attributes, weather attributes, congestion attributes, and time-slot attributes; one or more hidden layers implementing non-linear activation functions such as rectified linear units; and an output layer that outputs a scalar evaluation value. The server stores neural network parameters, including weights and biases for each layer, in a model-parameter table or in a serialized model file in the storage device. The server loads the parameters into memory when executing the evaluation-computation module and uses them to perform forward propagation for each combination. This neural-network-based scoring differs from a human heuristic in that it automatically learns complex interactions between features, such as a higher sensitivity to crowding at certain types of locations or at certain times, which are not easily captured by fixed rules.

The server selects visit candidates by sorting combinations by evaluation value and selecting one or more combinations that satisfy additional constraints such as minimum evaluation value and non-overlapping time slots. The evaluation-computation module may apply specific rules, such as discarding combinations with precipitation probability above a threshold for outdoor locations, or penalizing combinations where the congestion score exceeds a threshold. These rules are implemented as deterministic filters applied after scoring and stored in a configuration table so that they can be modified without changing core code.

The server generates a prompt sentence for a generative AI model by invoking the generative-AI-integration module. The server constructs an internal structured representation that includes: identifiers and names of selected visit candidates, their scheduled dates and times, textual summaries of weather conditions and congestion levels, and explanations of why the evaluation value is high (for example, “clear weather,” “low congestion,” or “matches usual preference for afternoon visits”). The generative-AI-integration module formats this representation into a prompt sentence in natural language. For example, the server generates a prompt sentence such as:

“The user wants to visit several points of interest. For this user, the system has selected the following visit candidate: visit Tokyo Tower on Saturday afternoon. The weather at that time is sunny with comfortable temperature, and predicted congestion is low. Based on this context, generate a friendly, concise recommendation in natural language that explains why this visit time and place are optimal.”

In another example, the server generates a prompt sentence such as:

“The system has calculated evaluation scores for possible visits based on user availability, weather, and congestion. The highest-scoring option is to visit Tokyo Tower on Saturday from 14:00 to 16:00, with clear weather and low congestion. Please generate a natural-language recommendation sentence that describes this plan and its advantages for the user.”

The server transmits the prompt sentence to a generative AI model that is hosted either as an external service or within a local generative information processing apparatus. In one embodiment, the generative AI model is a transformer-based neural network trained for natural language generation. The model includes an embedding layer, multiple self-attention layers, and a language modeling output layer. The server calls the model via an API, supplying the prompt sentence and specific generation parameters such as maximum token length and temperature. The model outputs a recommendation sentence in natural language.

The server receives the generated sentence and stores it in the database along with the corresponding visit candidate.

The terminal obtains the recommendation sentence from the server via the network interface.

The terminal displays the recommendation sentence, together with structured summary data such as the selected location, date, time, and expected conditions, on the display unit. The user reads the recommendation and may decide to follow or ignore the suggestion. After the proposed visit date and time pass, the terminal prompts the user to provide evaluation information through a graphical user interface. The user inputs, for example, a numerical rating, a binary indicator indicating whether the recommendation was followed, and optional free-text comments.

The terminal transmits the evaluation information to the server. The server stores the evaluation data in a feedback table, including fields for user identifier, location identifier, time slot, evaluation value predicted by the system, actual rating, and optional text. The feedback-learning module of the server analyzes the stored feedback. The module implements, for example, a supervised learning approach where the difference between predicted evaluation value and user rating is treated as an error. The server computes a loss function such as mean squared error aggregated over feedback samples, and uses a gradient-based optimization algorithm to update the weighting coefficients or neural network parameters. The server may perform mini-batch gradient descent by periodically selecting a subset of recent feedback samples, computing gradients with respect to each parameter, and updating the parameters according to a learning rate. This continuous adjustment of weights allows the system to adapt its scoring to each user's observed preferences.

In one embodiment, the feedback-learning module also uses feature-level statistics. The server clusters feedback samples by contextual conditions such as weather type, congestion level, and time-of-day classification, and computes average ratings in each cluster. The server increases the weight associated with features that correspond to clusters with higher average ratings and decreases weights for features associated with clusters with lower average ratings.

This clustering-based adjustment improves learning stability and reduces sensitivity to outlier ratings. Parameters controlling clustering granularity and weight-update magnitude are stored in a configuration table and can be tuned to balance adaptation speed and robustness.

The described integration of structured contextual data, generative AI-based language generation, and feedback-driven parameter updating improves computer technology in several respects. The server reduces redundant network calls and computation by associating each location-time combination with cached weather and congestion attributes in the database, thereby avoiding repeated acquisition of the same external data for similar queries.

The normalization of heterogeneous data into a unified internal structure allows efficient use of database indices and reduces query complexity, which improves data retrieval performance and lowers latency in generating recommendations.

The server also improves the efficiency of generative AI usage by constructing compact and context-rich prompt sentences rather than transmitting raw or redundant data. Because the prompt sentence is generated from structured data that already encodes evaluation results and selection reasons, the generative AI model can focus on natural-language expression rather than recomputation of context. This reduces the token length required for each call to the model, reduces communication overhead between the server and the generative AI service, and decreases inference time. The generative AI integration is not a mere automation of manual drafting of travel descriptions; instead, it is a technically specific use of a generative model that is optimized by structured, machine-friendly prompt construction.

Furthermore, the server's feedback-learning mechanism improves the underlying scoring algorithm, leading to higher precision in recommending location-time combinations that the user is likely to appreciate. By continuously updating weights or neural network parameters in response to structured feedback, the server avoids static heuristics and gradually converges to a user-tailored model. This reduces the number of low-utility recommendations shown to the user, decreasing wasted bandwidth and processing time in the terminal and server. The system thus achieves a technical effect of increasing the signal-to-noise ratio of recommendations and lowering the rate of ineffective computational operations.

In another embodiment, the server employs an ensemble of models: a rule-based filter to enforce hard constraints (such as excluding times with severe weather), a neural-network-based scorer for subtler preference interactions, and a secondary regression model that estimates expected satisfaction. The processor combines outputs of these models into a final evaluation value. The modular architecture enables distributed execution on multiple processing units or threads, leveraging parallel computation for batch evaluations of many location-time combinations. This parallelization further decreases response time when generating visit candidates and demonstrates improved scalability of the server when serving many users concurrently.

The terminal may also cache recent recommendations and context data locally. The terminal can request only incremental updates from the server when the user's availability or preferences change slightly, instead of requesting a complete recomputation. This incremental update mechanism, implemented by the server and terminal in combination, reduces communication load and shortens perceived response time, producing a technical effect that is distinct from human manual planning.

Alternative embodiments can vary the data structures, algorithms, and model types. In one variation, the server uses a gradient-boosted decision tree model instead of a neural network for the evaluation-computation module. In another variation, the generative AI model operates on a domain-specific control language generated by the server, which is then converted into natural language using a separate decoding component. In yet another variation, the server uses a recurrent neural network or a sequence-to-sequence architecture to generate entire itineraries for multiple locations and days, and incorporates feedback on multi-day plans. In each case, the server maintains the core features of integrating heterogeneous contextual data, constructing structured prompt sentences, and updating internal parameters based on feedback.

Because the server uses specific data structures, defined scoring algorithms, explicit parameter-update schemes, and an architecture that combines deterministic filters with adaptive models, the invention goes beyond an abstract idea of recommending travel destinations. The described system improves the functioning of the computer itself by optimizing data storage and retrieval, reducing unnecessary external API calls, structuring prompt generation to minimize generative-model overhead, and continuously shaping computational behavior in response to prior outcomes. The user thus benefits from more accurate and timely visit recommendations, while the underlying computing infrastructure operates with improved efficiency and technical performance.

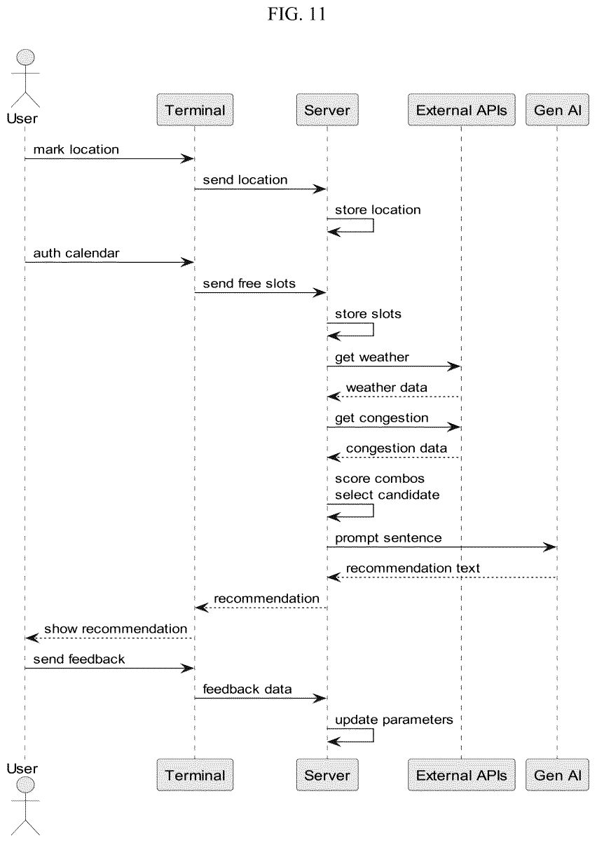

The following describes the processing flow using FIG. 11.

### Step 1:

The user designates locations to visit on an information-sharing application.

The terminal receives, as input, user operations such as tapping a “want to visit” button on content associated with a physical location. The terminal calls an information-sharing service API and obtains, as intermediate data, a list of items containing identifiers, textual descriptions, and geographic metadata. The terminal extracts, for each item, a location name, coordinates, and an application-specific identifier, and creates a normalized data structure.

The terminal sends this normalized data to the server via a network interface. The output of this step is a request containing structured location data transmitted from the terminal to the server.

### Step 2:

The server stores user-desired locations in a database.

The server receives, as input, a network message including user identifier and normalized location data. The server parses the message, validates field types and formats, and checks for duplicates by querying existing records in a location table. The server performs data processing that includes assigning internal location identifiers, mapping external identifiers to internal keys, and normalizing text fields. The server then executes database insert or update operations through a database management system. The output of this step is a set of persistent records in the database representing locations that the user desires to visit.

### Step 3:

The terminal acquires schedule data and sends user availability to the server.

The terminal receives, as input, user authorization to access calendar information. The terminal calls a schedule-management application interface to retrieve event data for a defined period. The terminal processes the event list to derive free time intervals by subtracting busy intervals from a baseline time range. The terminal represents each free interval by a start time, an end time, and the associated user identifier. The terminal sends these free intervals to the server as structured data. The output of this step is a set of user-availability time slots delivered to the server.

### Step 4:

The server stores user-availability time slots in the database.

The server receives, as input, structured data describing free time intervals linked to a user.

The server validates time formats, checks that start times precede end times, and ensures that intervals do not contain invalid values. The server performs data processing to merge or split intervals if necessary, for example combining contiguous or overlapping intervals. The server executes database insert operations into a time-slot table, associating each interval with the corresponding user identifier. The output of this step is a set of persistent time-slot records linked to the user.

### Step 5:

The server acquires weather information for each location-time combination.

The server reads, as input, the set of locations and time slots stored in the database. The server computes all combinations of locations and time slots that are eligible for visits, forming a list of combination identifiers. For each combination, the server calls a weather-information API with geographic coordinates and time parameters. The server receives raw weather data as structured responses. The server processes this data by extracting relevant fields such as condition code, temperature, and precipitation probability, and by computing derived features such as a comfort index or a binary rain indicator. The server writes the processed features back to the database in a weather-attribute table keyed by each location-time combination. The output of this step is a set of normalized weather attributes associated with each combination.

### Step 6:

The server acquires congestion information for each location-time combination.

The server receives, as input, the same set of eligible combinations or a subset filtered by initial conditions. For each combination, the server calls a congestion-information API with location identifiers or coordinates and target time information. The server receives congestion-related data such as crowd scores or qualitative labels. The server converts labels to numeric scores by applying a mapping rule, and may compute predicted congestion for the target time by interpolating between historical data points. The server stores the resulting congestion attributes in a congestion-attribute table associated with the corresponding location-time combinations. The output of this step is a set of congestion attributes for each combination.

### Step 7:

The server computes evaluation values for location-time combinations.

The server takes, as input, feature vectors assembled from location attributes, weather attributes, congestion attributes, and time-slot attributes for each combination. The server loads model parameters, such as weights and biases of a scoring function or a neural network, from a configuration store. The server performs data processing by applying the scoring function to each feature vector, which may include matrix multiplications, non-linear activations, and aggregation operations. The server outputs a scalar evaluation value for each combination and writes these values into a combination table in the database. The output of this step is a ranked list of combinations, each with a computed evaluation value.

### Step 8:

The server selects visit candidates based on evaluation values and constraints.

The server receives, as input, evaluation values and associated metadata for all combinations.

The server filters combinations using predefined constraints such as minimum score thresholds, exclusion of intervals with severe weather, and avoidance of overlapping time slots. The server sorts the remaining combinations in descending order of evaluation value.

The server selects one or more highest-scoring combinations as visit candidates and marks them as selected in the database. The output of this step is a set of visit candidates, each consisting of a location and a specific time slot.

### Step 9:

The server constructs structured context data for prompt generation.

The server receives, as input, the selected visit candidates together with their associated weather attributes, congestion attributes, and evaluation values. The server creates an internal context object that includes location names, visit dates and times, textual summaries of environmental conditions, and reasons derived from feature contributions (for example, low congestion and favorable weather). The server may compute per-feature contributions to the total evaluation value using techniques such as feature-weight multiplication or simple sensitivity analysis. The server stores this context object temporarily in memory for use in prompt construction. The output of this step is a structured context representation for each visit candidate.

### Step 10:

The server generates a prompt sentence for a generative AI model.

The server takes, as input, the structured context representation produced in the previous step.

The server inserts context fields into a predefined prompt template that describes the user situation, selected visit candidate, and reasons for selection in natural language. The server performs string-assembly operations, including concatenating text fragments, formatting date and time values, and inserting condition descriptions. The server outputs a prompt sentence such as:

“The user wants to visit several points of interest. For this user, the system has selected the following visit candidate: visit Tokyo Tower on Saturday afternoon. The weather at that time is sunny with comfortable temperature, and predicted congestion is low. Based on this context, generate a friendly, concise recommendation in natural language that explains why this visit time and place are optimal.”

The output of this step is a prompt sentence ready to be submitted to the generative AI model.

### Step 11:

The server obtains a recommendation sentence from the generative AI model.

The server sends, as input, the generated prompt sentence to a generative AI model via an API of a generative information processing apparatus. The server specifies generation parameters such as maximum length, randomness level, and stopping criteria. The generative AI model processes the prompt and returns a natural-language recommendation sentence. The server receives the recommendation sentence, performs post-processing such as trimming whitespace and checking for prohibited content, and stores the final sentence in the database, linked to the corresponding visit candidate. The output of this step is a stored natural-language recommendation sentence associated with each candidate.

### Step 12:

The terminal retrieves and presents the recommendation sentence to the user.

The terminal requests, as input, recommendation data from the server, including visit candidates and associated recommendation sentences. The terminal receives a response containing location names, visit times, and natural-language text. The terminal performs UI-level data processing, such as converting timestamps into local time and formatting text for display. The terminal renders the recommendation sentence and relevant structured information on the display. The output of this step is a visual or auditory presentation of the recommendation to the user.

### Step 13:

The user provides evaluation information regarding the recommendation.

The user receives, as input, the recommendation presented on the terminal. The user evaluates whether the recommendation matches personal preferences or actual experience, and then enters feedback using the input interface. The user may select a rating value, indicate whether the recommendation was followed, and optionally enter comments. The terminal collects these inputs, formats them as structured data, and prepares them for transmission. The output of this step is a feedback payload representing evaluation information created by the user.

### Step 14:

The terminal sends feedback to the server.

The terminal takes, as input, the user-generated evaluation information and associated identifiers for the visit candidate and user. The terminal performs basic validation, such as checking numeric ranges and non-empty identifiers. The terminal then sends the feedback payload to the server through a feedback API endpoint. The output of this step is a network message containing structured evaluation information delivered to the server.

### Step 15:

The server stores and organizes feedback data.

The server receives, as input, the feedback payload from the terminal. The server verifies the consistency of identifiers and checks that the referenced visit candidate exists. The server timestamps the feedback entry and assigns an internal feedback identifier. The server inserts the feedback record into a feedback table, associating it with the user, location, time slot, and the evaluation value that was originally predicted for that combination. The output of this step is a persistent set of feedback records suitable for analysis and model updating.

### Step 16:

The server analyzes feedback and updates evaluation parameters.

The server reads, as input, historical feedback records, contextual attributes (weather, congestion, time-of-day), and existing model parameters. The server computes statistical measures such as average rating per feature category and error values between predicted evaluation values and actual user ratings. The server performs data processing that includes calculating gradients of an error function with respect to weighting coefficients or neural network parameters. The server updates parameters by applying a learning rule, such as gradient descent with a predefined learning rate, and writes updated parameters back to the configuration store. The output of this step is a revised set of weights and parameters that will be used in future evaluation computations.

### Step 17:

The server applies updated parameters in subsequent recommendation cycles.

The server loads, as input, the updated weights and model parameters when it next computes evaluation values for new combinations of locations and time slots. The server uses the updated parameters in the same scoring function or neural network forward pass described previously. The server thereby produces evaluation values that more closely reflect observed user preferences. The output of this step is a technically improved scoring behavior of the system, resulting in more accurate and personalized future visit candidates.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional recommendation systems for visit planning generally treat schedule information, weather information, and congestion information as separate data streams and apply simple filtering or rule-based logic at the application level. Such systems typically require an application developer to hard-code heuristic rules, and they are not capable of adaptively learning from user feedback in a systematic way. As a result, these systems often generate sub-optimal visit plans that do not sufficiently reflect the user's real constraints and preferences, and they frequently produce inconsistent or non-actionable recommendations when multiple external information sources are combined.

Furthermore, in many existing solutions, the integration of external information providing services, such as schedule management services, meteorological services, and congestion or popularity services, is implemented as ad hoc calls scattered throughout the application logic.

This leads to redundant computations, inefficient use of network and processor resources, and increased latency when computing candidate visit time periods. There is no standardized internal representation of time-series constraints across schedule, weather, and congestion, which makes it difficult for a computing device to systematically intersect and optimize these constraints. Consequently, the computing resources of the server are not efficiently utilized, the response time for generating visit plans is increased, and scalability is impaired as the number of users and external data sources grows.

Additionally, the use of generative artificial intelligence models in this technical field has often been limited to simple text generation based on loosely structured prompts. Existing systems do not define a rigorous mechanism through which a processor converts heterogeneous time-series and attribute data—such as schedule slots, weather forecasts, congestion levels, user preferences, and past visit histories—into a unified prompt sentence that a generative artificial intelligence model can reliably analyze. Without such a mechanism, the generative artificial intelligence model cannot consistently produce high-quality, machine-parsable outputs, and the server cannot programmatically close the loop between generated recommendations and user feedback for continuous optimization.

Therefore, there is a need for an improved computer-implemented technique that (i) systematically acquires and normalizes schedule information, weather information, and congestion information into a common temporal representation, (ii) efficiently computes candidate visit time periods by intersecting these multiple constraints, and (iii) programmatically generates and refines prompt sentences for a generative artificial intelligence model using stored user preference information and past visit history information. Such a technique should improve the functioning of the server itself by reducing redundant processing, enabling structured interaction with the generative artificial intelligence model, and establishing a feedback loop that adapts subsequent computations and prompt generation based on user behavior, thereby enhancing the overall efficiency, reliability, and scalability of the visit planning process executed by a computing device.

The specific processing by the specific processing unit 290 of the data processing device 12 in Application Example 1 is realized by the following means.

The present invention provides a server comprising a processor and a non-transitory storage device, the processor being configured to acquire information regarding a facility or location that a user desires to visit and register the information as structured data stored in the non-transitory storage device; to acquire behavioral schedule information of the user by cooperating with a schedule management application or a schedule management service and calculate, based on the behavioral schedule information, time periods in which the user is available for visiting; to acquire weather information for a predetermined geographic area via an external information providing service and extract, based on the weather information, time periods that satisfy visit-appropriate weather conditions; to acquire congestion state information regarding the facility or location via an external information providing service and extract, based on the congestion state information, time periods in which a congestion degree is below a predetermined threshold; to integrate, based on time information, the time periods in which the user is available for visiting, the time periods that satisfy the visit-appropriate weather conditions, and the time periods in which the congestion degree is below the predetermined threshold, and identify, by computation, candidate visit time periods in which the time periods overlap; to read preference information of the user and past visit history information from the non-transitory storage device and generate a prompt sentence to be input to a generative artificial intelligence model by combining the candidate visit time periods with the preference information and the past visit history information; to input the prompt sentence to the generative artificial intelligence model and acquire, from the generative artificial intelligence model, a proposal result including a recommended visit time period for the facility or location and a reason for the recommendation; and to transmit the proposal result to a user terminal, acquire acceptance information or modification information from the user terminal, record the acceptance information or the modification information as the past visit history information in the non-transitory storage device, and reflect the past visit history information in at least one of generation of a subsequent prompt sentence and identification of a subsequent candidate visit time period. This enables the server to improve its internal operation by normalizing heterogeneous external data into a unified temporal model, efficiently computing optimized candidate visit time periods, and systematically interacting with the generative artificial intelligence model through structured prompt sentences and feedback, thereby enhancing computational efficiency, consistency of recommendations, and adaptability of the visit planning process performed by the computing system.

The term “facility or location” refers to a physical place that can be visited by a user, including but not limited to commercial establishments, public spaces, or points of interest represented as identifiable entities in a data structure.

The term “user” refers to an individual or entity that interacts with the system to obtain recommendations for visiting a facility or location, and for whom schedule information, preference information, and visit history information are maintained.

The term “user terminal” refers to an information processing device operated by the user, such as a mobile communication device, a portable computing device, or a stationary computing device, that is capable of communicating with the server over a communication network.

The term “processor” refers to one or more hardware processing units, such as a central processing unit or a processing core, configured to execute program instructions to perform the functions described in the specification and claims.

The term “non-transitory storage device” refers to one or more physical storage media, such as a magnetic storage medium, a semiconductor memory, or an optical storage medium, that store data and program instructions in a non-temporary manner.

The term “structured data” refers to data stored in a predetermined format, such as records in a relational database or entries in a structured file, in which fields and relationships between fields are explicitly defined to enable programmatic querying and updating.

The term “behavioral schedule information” refers to information representing times and durations of planned user activities, including at least start times, end times, and optionally descriptive attributes of scheduled events, which indicate when the user is busy or available.

The term “schedule management application or schedule management service” refers to a software component or network-based service that manages calendar or schedule information for a user and provides an interface through which the system can read the user's scheduled events.

The term “time period in which the user is available for visiting” refers to an interval of time, derived from the behavioral schedule information, during which no conflicting scheduled events exist and the user can visit a facility or location.

The term “weather information” refers to forecast or observed meteorological data for a geographic area, including at least one of temperature, precipitation, weather condition codes, or other meteorological parameters relevant to determining visit suitability.

The term “visit-appropriate weather conditions” refers to a set of criteria applied to the weather information, such as thresholds or rules, for determining whether a given time period is suitable for visiting a facility or location from a meteorological perspective.

The term “congestion state information” refers to data indicating a level of occupancy, crowding, or busyness at a facility or location, including but not limited to time-dependent popularity scores, estimated visitor counts, or congestion levels.

The term “congestion degree” refers to a quantitative or qualitative measure derived from the congestion state information that represents how crowded a facility or location is at a given time.

The term “predetermined threshold” refers to a reference value or condition, which may be fixed or configurable, used to compare against a congestion degree or other metric in order to determine whether the metric is acceptable for visit planning.

The term “candidate visit time period” refers to an interval of time determined by the processor as a potential visit window by intersecting at least an available time period of the user, a time period satisfying visit-appropriate weather conditions, and a time period with a congestion degree below a predetermined threshold.

The term “preference information of the user” refers to data representing the user's explicit or inferred likes, dislikes, or tendencies related to visiting facilities or locations, including preferred facility types, preferred visiting times, or environmental conditions.

The term “past visit history information” refers to data associated with facilities or locations previously visited or planned by the user, including at least past visit times, accepted recommendations, rejected recommendations, or evaluations of visits.

The term “generative artificial intelligence model” refers to a machine-implemented model, such as a neural network-based language model, that generates output data, including natural language text, in response to input data, and is capable of inferring recommendations based on prompt sentences.

The term “prompt sentence” refers to a text or structured text sequence constructed by the processor, which encodes schedule information, weather information, congestion information, preference information, past visit history information, and candidate visit time periods for input to the generative artificial intelligence model.

The term “proposal result” refers to output data generated by the generative artificial intelligence model in response to a prompt sentence, the output data including at least one recommended visit time period and optionally an explanation or reason for the recommendation.

The term “acceptance information” refers to information indicating that the user has approved or adopted a recommended visit time period included in the proposal result.

The term “modification information” refers to information indicating that the user has changed at least part of a recommended visit time period, such as by adjusting a start time or end time, before adopting the modified visit plan.

The term “external information providing service” refers to any network-accessible service or system that supplies data such as weather information, congestion state information, or position information to the server via a communication interface.

The term “position information providing service” refers to an external information providing service that supplies location-related data, including identifiers and attributes of facilities or locations, based on geographic coordinates or search queries.

The term “information sharing service” refers to an external information providing service that aggregates and distributes user-generated or system-generated information about facilities or locations, including reviews, tags, or bookmarks, which can be used to obtain information regarding a facility or location that a user desires to visit.

The term “time-series information” refers to information that is associated with points or intervals on a time axis, including but not limited to timestamps, durations, and sequences of time-dependent values such as congestion degrees or weather parameters.

The term “attribute information” refers to information representing properties or characteristics of entities, such as facilities or locations, user preferences, or events, which are not limited to time-indexed values and can include categorical, numerical, or descriptive data.

The term “natural language format” refers to a representation of information expressed using words, phrases, and sentences of a human language, which can be parsed and interpreted by a generative artificial intelligence model.

The term “structured text format” refers to a representation of information using a syntactically constrained textual structure, such as markup, key-value pairs, or delimited fields, that facilitates machine parsing and interpretation by a generative artificial intelligence model.

The term “optimal visit plan” refers to a visit schedule for at least one facility or location that is determined, based on predefined criteria, to best satisfy a combination of constraints and preferences, including at least user availability, weather conditions, and congestion levels.

In one embodiment, a server implements the claimed system as a network-connected computing device that cooperates with one or more terminals operated by a user. The server includes at least one hardware processor, a main memory, and a non-transitory storage device such as a magnetic disk or solid-state drive. The server executes an operating system, such as a general-purpose server operating system, and an application stack including a runtime for a high-level programming language, for example a Python runtime, a web application framework, for example a micro-framework providing HTTP routing, and a relational database engine, for example a lightweight SQL database engine. The server further communicates over a packet-switched network using a network interface controller and executes an HTTP server component to expose application programming interfaces (APIs) to the terminals.

The terminal operates as a client device such as a smartphone, tablet, or personal computer, and includes a processor, a memory, a display, and a communication interface. The terminal executes a client application implemented, for example, as a native mobile application using a user interface toolkit such as a mobile user interface framework, or as a web application rendered in a browser. The terminal communicates with the server using HTTPS over a wireless or wired communication network.

The user interacts with the terminal via a graphical user interface. The user selects a facility or location of interest, such as a restaurant, café, shop, or other point of interest, which is internally represented as an entity in the server's structured data store. The user may select the facility or location from a map view, a list view, or a search interface displayed on the terminal. The user grants permission, via standard authorization dialogs on the terminal, for the terminal and server to access the user's schedule data, such as calendar events, and optionally to use location information and account data.

The server stores data in the non-transitory storage device using a relational schema. In one embodiment, the server uses a relational database engine such as a lightweight SQL database accessed via an object-relational mapping library. The server defines tables including at least: a user table holding user identifiers and profile attributes; a place table holding facility or location identifiers, names, categories, and geographic coordinates; a desired_place table associating users with facilities or locations they wish to visit; a schedule_event table holding behavioral schedule information; a free_slot table holding time periods in which the user is available; a weather_slot table holding time periods that satisfy visit-appropriate weather conditions; a congestion_slot table holding time periods in which congestion degrees are below a predetermined threshold; a preference table holding preference information of the user; a visit_history table holding past visit history information; and an ai_log table holding prompt sentences and responses of a generative AI model.

The server uses such structured tables to normalize heterogeneous external data into a unified temporal representation. Specifically, the server represents all time-dependent constraints as intervals defined by start and end timestamps, stored, for example, as coordinated universal time in a normalized datetime format. This representation enables the server to apply interval intersection algorithms implemented in executable instructions running on the processor, thereby improving computational efficiency as compared to ad hoc string-based or unstructured time handling.

The server communicates with external information providing services to acquire schedule management, weather, congestion, and position data. In one embodiment, the server cooperates with a calendar management service accessible via an HTTP-based API. The terminal initiates an authorization flow, such as an OAuth-based authorization, and stores access tokens in an encrypted storage area. The terminal obtains calendar events within a given date range and transmits the events to the server as structured JSON data over HTTPS.

The server validates and parses the received events, converts them to internal canonical date and time formats, and stores them as records in the schedule_event table.

The server then calculates free time periods in which the user is available for visiting. The server performs this calculation by loading scheduled events for the relevant days from the schedule_event table into memory, sorting them by start time using an in-memory sorting algorithm, and scanning the sorted events to identify gaps between an event's end time and the next event's start time. The server writes these gaps as free_slot records. This algorithmic calculation allows the processor to systematically derive availability without requiring manual reasoning by the user, and it is optimized to run in time proportional to the number of events.

The server acquires weather information by sending HTTP requests to a meteorological data service. The server supplies geographic coordinates and time ranges as query parameters. The meteorological data service returns data in a structured format that includes forecast time points, weather condition codes, precipitation probabilities, and temperature values. The server parses this data and, for each time point, applies rule-based computations implemented as comparison operations on numeric and categorical fields. For example, the server labels a time point as weather-favorable if the precipitation probability is below a threshold and if the weather condition code corresponds to clear or light conditions. The server groups consecutive favorable time points into contiguous weather_slot intervals. By precomputing these intervals and storing them in the database, the server reduces the computation required at recommendation time and improves overall response latency.

The server acquires congestion state information by calling a congestion or popularity data service, such as a mapping or traffic-related API, using facility or location identifiers and geographic coordinates. The congestion data service returns, for example, per-hour occupancy levels. The server converts raw occupancy values to normalized congestion degrees, for instance scaling them to a 0-100 range through arithmetic operations. The server then applies thresholding: it marks each time unit, such as each hour, as low congestion if the congestion degree is below a predetermined threshold. The server merges contiguous low-congestion time units into congestion_slot intervals. These operations are implemented as deterministic algorithms using integer and floating-point arithmetic and loop constructs, and they contribute to reducing the volume of data required for subsequent computations by consolidating high-resolution time-series data into simplified intervals.

The server integrates the time periods in which the user is available for visiting, the time periods that satisfy visit-appropriate weather conditions, and the time periods with acceptable congestion degrees. To achieve this, the server retrieves free_slot, weather_slot, and congestion_slot records from the database and loads them into memory as arrays or lists of interval objects. Each interval object contains at least a start timestamp, an end timestamp, and, optionally, quality scores for weather and congestion. The server applies an interval intersection algorithm that iterates through the three sorted interval lists and determines overlapping periods by comparing start and end timestamps. For each tri-overlap, the server calculates a composite score using predetermined weights for schedule suitability, weather quality, and congestion relief. The server stores resulting candidate intervals as candidate visit time periods in memory, optionally writing them to a temporary or persistent table.

By using interval objects and composite scoring, the server improves technical performance relative to naive approaches that repeatedly call external services during recommendation generation. The server achieves lower network load by externalizing external data acquisition to discrete phases and pre-aggregating results into interval structures. The interval intersection algorithm avoids scanning entire raw time-series data multiple times, thereby reducing processor cycles and memory overhead.

The server stores preference information of the user and past visit history information in the preference and visit_history tables. The server may record, for example, categories of facilities previously selected by the user, times of day when the user accepted recommendations, durations of visits, and user feedback scores. The server uses this information as structured numeric and categorical features when computing scores for candidate time periods and when constructing prompt sentences for a generative AI model.

In one embodiment, the server uses a generative AI model based on a transformer-type neural network architecture. The transformer model comprises multiple layers of self-attention and feed-forward sub-layers, trained on large corpora of text data. The model receives, as input, a sequence of tokens representing a prompt sentence, and outputs a sequence of tokens representing a natural language response. The server may access this model as a remote service via an HTTP-based API, or execute a locally hosted instance of the model using an inference engine optimized for matrix computations.

The server constructs the prompt sentence by encoding time-series information and attribute information into descriptive, yet structured, natural language. For example, the server may generate a prompt sentence such as:

“The user has marked the café ‘Blue Sky Café’ as a place they want to visit this weekend.

User's free time windows: Saturday 10:00-13:00, Sunday 15:00-18:00 (local time).

Weather forecast: Saturday morning will be rainy with high precipitation probability; Sunday afternoon will be sunny and dry.

Congestion forecast: the café is very crowded on Sunday 14:00-17:00 but less crowded after 17:00.

User preferences: the user prefers quiet cafés, usually stays about 60 minutes, and tends to accept recommendations that avoid rain.

Based on this information, propose the single best visiting time window for ‘Blue Sky Café’ this weekend.

Explain briefly why the suggested time is optimal with respect to the user's schedule, the weather, and congestion levels.

Output your answer in the following format:
Recommended time: [start time]−[end time]
Explanation: [one or two concise sentences]”

The server applies deterministic logic to assemble such a prompt sentence. The server formats free time windows, weather conditions, congestion descriptions, and preference-derived statements into predefined sentence templates. The server encodes numeric values, such as probabilities and congestion degrees, into linguistic expressions such as “high,” “moderate,” or “low,” using threshold-based mapping. These steps represent a non-conventional use of text generation infrastructure: the server does not simply relay human-written instructions but instead algorithmically compresses multidimensional structured data into a natural language representation that the transformer model can exploit.

The server submits the prompt sentence to the generative AI model by sending an inference request containing the text. The server may specify model parameters such as maximum output length, temperature, and top-k or top-p sampling values to control response determinism and variability. Internally, the transformer model computes attention weights across tokens, multiplies inputs with learned weight matrices representing attention heads and feed-forward layers, and generates output token probabilities based on a softmax function.

The server does not treat this as a black-box “judgment” but as a sequence of matrix operations executed on specialized hardware such as vector units or graphics processing units.

The server receives the generated text as a proposal result. In one example, the generative AI model returns:

“Recommended time: Sunday 17:00-18:00

Explanation: At this time, the user is free, the weather is clear, and the café is less crowded, providing a quiet environment that matches the user's preferences.”

The server post-processes this text by applying pattern-matching rules or simple parsing logic to extract time expressions and explanation sentences. The server converts extracted time information back into structured timestamps and compares them with previously computed candidate intervals to verify consistency. The server stores the resulting recommendation in the visit_history table and the full interaction (prompt and response) in the ai_log table, thereby enabling reproducibility and analysis.

The terminal displays the proposal result on a graphical interface, showing the facility or location name, the recommended time period, and the explanation. The user may accept the recommendation, modify it, or reject it. If the user accepts or modifies the recommended time period, the terminal writes the confirmed visit into a calendar management system using a calendar API available on the terminal's operating system. In this way, the system is not limited to abstract scheduling operations but directly controls the configuration of real calendar entries on computing devices, which affects subsequent notifications, alarms, and device behavior.

The server records acceptance information or modification information as part of the past visit history information. In some embodiments, the server aggregates user feedback statistics and updates model-side preference weights. For example, the server may assign higher weight to weather conditions if users frequently reject recommendations with poor weather but accept those with better forecasts. The server can encode such adjustments in updated parameters for scoring functions used in interval intersection or in auxiliary control parameters passed to the generative AI model, such as altering instructions in subsequent prompt sentences to emphasize particular constraints.

The server implements this feedback loop to achieve technical improvements. Because the server normalizes, stores, and reuses past decisions, the server reduces future search space for candidate time periods, and can pre-rank intervals with higher historical acceptance likelihood. This reduces computation time when generating new recommendations and improves the relevance of results. The server also reduces redundant external API calls by caching and indexing previously acquired weather and congestion data for time periods already covered by prior recommendations.

In one variation, the server executes a locally hosted generative AI model rather than a remote service. The server loads model parameters into memory and executes inference using a linear algebra library and hardware-accelerated instructions. The server may perform fine-tuning or continual learning on the model using stored ai_log and visit_history data. In such a case, the server constructs training examples where inputs are previously used prompt sentences and outputs are accepted or modified recommendations. The server defines an objective function, such as a cross-entropy loss between model outputs and target sequences representing human-accepted recommendations. The server updates model weights using gradient-based optimization, for example stochastic gradient descent or adaptive moment estimation, applied to mini-batches of training data. This process allows the model to adapt specifically to the user population served by the system.

In another variation, the server implements a hybrid algorithm combining rule-based filtering and AI-based ranking. The server first restricts candidate visit time periods through deterministic interval intersection and threshold checks. The server then applies the generative AI model primarily as a ranking and explanation engine, passing only a small set of top-N candidate intervals and obtaining an ordered recommendation along with textual rationale. This design reduces the token length of prompt sentences and the computational load on the AI model, leading to faster response times and lower server utilization.

In yet another embodiment, the server supports multiple users and multiple terminals simultaneously by handling concurrent HTTP requests and isolating data per user in the database schema. The relational structure and interval-based representation enable efficient indexing on user identifiers and timestamps, which in turn allows the server to answer queries such as “next available low-congestion daytime window” with logarithmic or sub-linear complexity through index lookups. These computational properties constitute an improvement in computer operation as they reduce the number of full-table scans and expensive joins.

The system achieves technical effects beyond mere automation of a human mental process. A human user cannot feasibly maintain and intersect, in real time, fine-grained schedule, weather, and congestion time-series for many facilities across days or weeks. By contrast, the server performs structured interval computations, database queries, and model-based text generation using hardware-level acceleration and optimized algorithms, thereby realizing measurable improvements in processing time, accuracy of constraint satisfaction, and robustness of data management. The integration of interval-based preprocessing with generative AI prompt construction results in lower token counts, fewer API round-trips, and reduced network bandwidth consumption, all of which are improvements in computer resource utilization.

In addition, the server's method of encoding heterogeneous numerical and categorical features into structured natural language prompt sentences, combined with deterministic post-processing of generative outputs back into structured time intervals, establishes a specific, non-conventional interface pattern between symbolic database representations and neural-network text models. This pattern is not a generic application of text generation but a well-defined transformation pipeline that improves both machine interpretability and user-facing clarity. The resulting system constitutes an improvement to computer technology in the field of scheduling and recommendation engines, realized through concrete data structures, algorithmic flows, and neural-network usage patterns implemented on tangible computing hardware.

Various modifications and alternative embodiments can be adopted without departing from the spirit of the invention. The server may use different database technologies such as a document database instead of a relational database, while maintaining the essential interval representation. The server may employ alternative model architectures, such as recurrent neural networks or encoder-decoder models, instead of transformer-based models, provided that the models accept prompt sentences and output natural language recommendations. The terminal may be implemented as a vehicle head unit, a wearable device, or a smart home device, and may integrate visit recommendations with routing software, navigation units, or notification systems. In each case, the server, the terminal, and the user cooperate according to the described data structures and algorithms to realize improved visit planning that leverages a generative AI model and prompt sentences in a technically specific and efficient manner.

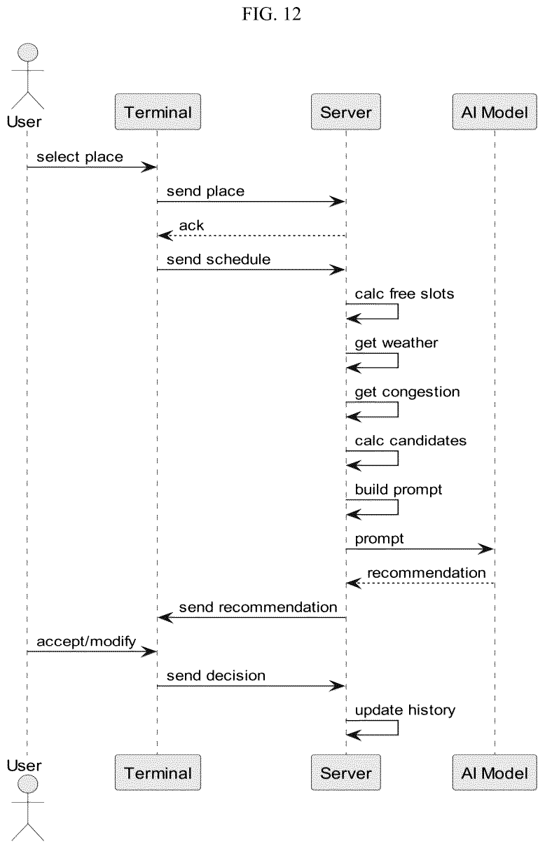

The following describes the processing flow using FIG. 12.

### Step 1:

The user operates the terminal to select a facility or location that the user desires to visit.

Input: A list or map of candidate facilities or locations displayed on the terminal.

Output: A specific facility or location selected by the user.

The terminal receives the user's selection event through the user interface framework and reads structured data for the selected facility or location, including at least an identifier, a name, a category, and geographic coordinates. The terminal then generates a request message including this structured data and transmits the request to the server over a network connection.

### Step 2:

The server receives the request from the terminal and registers the selected facility or location as structured data in a storage device.

Input: A request message containing the facility or location identifier, name, category, and geographic coordinates.

Output: A stored record in a facility or location table and an association record indicating that the user desires to visit the facility or location.

The server parses the request, validates required fields, and converts values such as coordinates and identifiers into internal formats. The server then executes database insert operations to store these values as rows in a structured table and creates an association row linking the user to the desired facility or location. By performing this data insertion and normalization, the server prepares consistent internal data for subsequent computations.

### Step 3:

The terminal obtains behavioral schedule information of the user from a schedule management application or schedule management service and sends this information to the server.

Input: Authorization credentials and user instructions to access a calendar or schedule.

Output: A schedule data set transmitted to the server, including start times and end times of scheduled events.

The terminal communicates with the schedule management application or service via an application programming interface, retrieves scheduled events for a specified date range, filters irrelevant fields, and converts date and time into a standardized textual representation.

The terminal then packages the event list into a structured message and transmits it to the server.

### Step 4:

The server receives the schedule data set and calculates time periods in which the user is available for visiting.

Input: A schedule data set containing event start times, end times, and optional descriptions.

Output: A set of free time intervals stored as structured records.

The server parses the schedule data, converts text-based times into internal datetime objects, and sorts events in ascending order of start time. The server then scans the sorted events and computes gaps between consecutive event end times and next event start times. For each gap longer than a minimum threshold, the server creates a free-time interval record and stores the interval in a dedicated free-slot table. These computations transform raw event data into explicit availability information usable in later steps.

### Step 5:

The server acquires weather information for a predetermined geographic area corresponding to the selected facility or location.

Input: Geographic coordinates of the facility or location and a target date or time range.

Output: A set of weather data points and derived weather-favorable time intervals.

The server sends a request to a meteorological data service using the coordinates and time range, receives forecast data, and parses parameters such as timestamps, weather condition codes, precipitation probabilities, and temperatures. The server then applies rule-based comparisons to each forecast point, marking points that satisfy defined visit-appropriate weather conditions. The server groups consecutive points satisfying the conditions into continuous intervals and stores these intervals as weather-slot records.

### Step 6:

The server acquires congestion state information for the selected facility or location and extracts low-congestion time periods.

Input: A facility or location identifier and a time range.

Output: A set of congestion degrees per unit time and a set of low-congestion intervals.

The server transmits a request to a congestion or popularity information service using the facility identifier and time parameters and receives time-series congestion data. The server normalizes the raw values into congestion degrees on a defined scale and compares each congestion degree with a predetermined threshold. For time units where the degree is below the threshold, the server marks the unit as low congestion, merges adjacent low-congestion units into longer intervals, and writes these as congestion-slot records. This processing converts high-granularity congestion data into compact intervals.

### Step 7:

The server integrates the user's free time intervals, the weather-favorable intervals, and the low-congestion intervals to identify candidate visit time periods.

Input: A set of free-slot intervals, a set of weather-slot intervals, and a set of congestion-slot intervals.

Output: A set of candidate visit time periods where all three conditions overlap.

The server loads the three interval sets into memory as sorted lists of interval objects. The server then executes an interval intersection algorithm that iteratively compares start and end times of intervals across the three lists. When the server finds time spans where intervals from all three lists overlap, the server computes their intersection and checks whether the resulting span meets a minimum visit duration. For each qualifying span, the server creates a candidate visit interval and optionally computes a composite score based on weather quality and congestion level. The server stores these candidate intervals for later use.

### Step 8:

The server retrieves preference information of the user and past visit history information to characterize the user's tendencies.

Input: A user identifier referencing stored preference records and visit history records.

Output: A collection of preference attributes and historical behavior metrics.

The server queries the preference table to obtain information such as preferred facility categories, typical visit durations, and favored times of day. The server also queries the visit_history table to extract data about previously accepted recommendations, rejected recommendations, and actual visit times. The server aggregates these values into numerical and categorical feature sets, such as counts of category selections, distributions of visit times, and averages of stay durations. These feature sets serve as parameters for scoring candidate intervals and for constructing a prompt sentence.

### Step 9:

The server generates a prompt sentence for a generative AI model by combining candidate visit time periods with the preference information and the past visit history information.

Input: The set of candidate visit intervals, the user's preference attributes, the past visit history metrics, and summaries of schedule, weather, and congestion data.

Output: A structured natural language prompt sentence describing the visit planning context and the requested output.

The server formats free slots, candidate intervals, weather conditions, congestion patterns, and user preferences into predefined textual templates. The server inserts specific date and time ranges and descriptive phrases corresponding to weather and congestion into these templates. For example, the server may produce a prompt sentence such as:

“The user has marked the café ‘Blue Sky Café’ as a place they want to visit this weekend.

User's free time windows: Saturday 10:00-13:00, Sunday 15:00-18:00 (local time).

Weather forecast: Saturday morning will be rainy with high precipitation probability; Sunday afternoon will be sunny and dry.

Congestion forecast: the café is very crowded on Sunday 14:00-17:00 but less crowded after 17:00.

User preferences: the user prefers quiet cafés, usually stays about 60 minutes, and tends to accept recommendations that avoid rain.

Based on this information, propose the single best visiting time window for ‘Blue Sky Café’ this weekend.

Explain briefly why the suggested time is optimal with respect to the user's schedule, the weather, and congestion levels.

Output your answer in the following format:
Recommended time: [start time]−[end time]
Explanation: [one or two concise sentences]”

The server uses this construction process to compress multidimensional structured data into a prompt sentence that the generative AI model can process.

### Step 10:

The server sends the prompt sentence to the generative AI model and obtains a proposal result.

Input: The generated prompt sentence describing candidate visit periods, constraints, and preferences.

Output: A natural language response including at least one recommended visit time period and an explanation.

The server transmits the prompt sentence to the generative AI model via an inference interface and specifies control parameters such as maximum output length and randomness settings. The generative AI model performs internal numerical computations on tokenized representations of the prompt and returns a sequence of tokens forming a textual response.

The server receives this text and parses it using pattern-matching or simple syntactic rules to extract structured fields such as a recommended start time, a recommended end time, and an explanation sentence. The server may verify that the recommended time falls within one of the candidate visit intervals and adjust or flag the result otherwise.

### Step 11:

The server transmits the proposal result to the terminal and records the interaction in storage.

Input: The structured recommendation data (recommended visit time, facility or location identifier, and explanation) and the original prompt sentence.

Output: A response message sent to the terminal and stored log records representing the recommendation event.

The server packages the recommendation into a response message containing textual descriptions and machine-readable time values. The server sends the message to the terminal via the network. The server also writes a log entry to the ai_log table including the prompt sentence, the raw response text, and the parsed recommendation fields. Additionally, the server inserts or updates entries in the visit_history table indicating that a recommendation has been issued for the corresponding facility or location and time period.

### Step 12:

The terminal receives the proposal result and displays it to the user.

Input: The response message containing the recommended visit time, facility or location details, and explanation.

Output: A user-readable display of the recommendation on the terminal screen.

The terminal parses structured fields in the response, converts timestamps into local time zone representations, and renders the facility or location name, the recommended time range, and the explanation text in the graphical user interface. The terminal may present buttons such as “Accept,” “Modify,” or “Reject,” allowing the user to respond to the recommendation.

### Step 13:

The user evaluates the recommendation and provides acceptance information or modification information via the terminal.

Input: The displayed recommendation, including recommended time period and explanation.

Output: A user action indicating acceptance, rejection, or a modified time period.

The user may tap “Accept” to confirm the suggested time, adjust the start or end time using input controls, or select “Reject.” The terminal captures the user's input and constructs a confirmation message containing a status indicator (accepted, modified, or rejected), the final chosen time period if applicable, and identifiers for the facility or location and the underlying recommendation.

### Step 14:

The terminal transmits the acceptance information or modification information to the server and updates local schedule data.

Input: The user's selection or modification and the original recommendation metadata.

Output: A network message sent to the server and an updated calendar entry on the terminal.

The terminal sends a confirmation request containing structured fields describing the user's decision to the server. In parallel, if the user has accepted or modified the recommended time, the terminal uses a calendar application interface to create or update a calendar event corresponding to the visit. The calendar event includes at least the facility or location name, the start time, and the end time, which are derived from the chosen visit time period.

### Step 15:

The server updates past visit history information based on the user's acceptance information or modification information and adjusts subsequent processing.

Input: The confirmation message containing the user's decision, the final visit time period if any, and the identifiers of the user and facility or location.

Output: Updated visit_history records and potentially adjusted parameters or metadata for future processing.

The server writes a new record or updates an existing record in the visit_history table to reflect whether the recommendation was accepted, modified, or rejected and to store the final visit time if any. The server may compute statistics such as acceptance rates per time-of-day, correlation between weather conditions and acceptance, and congestion tolerance levels. The server uses these statistics to adjust scoring parameters for future candidate visit time computation and to refine construction of future prompt sentences sent to the generative AI model.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional recommendation systems that propose visit timings and destinations for users typically rely on rule-based logic or static scoring functions that separately consume schedule information, weather information, and congestion information. Such systems are often implemented as monolithic workflows that are hard-coded at design time and are not able to adaptively change their behavior based on user feedback. As a result, these systems suffer from several technical problems in terms of computer technology.

First, conventional systems do not efficiently integrate heterogeneous external data sources, such as information sharing services, schedule management services, weather information services, and congestion information services, in a way that allows dynamic, context-rich generation of proposal messages. The processing logic for combining these heterogeneous data sources is usually embedded directly into application code, making it difficult to change how the data is combined without redeploying the system. This leads to poor extensibility and maintainability of the software modules that execute on a server.

Second, conventional systems have limited capability to express complex, user-specific reasoning in natural language while maintaining a clear computational separation between data acquisition, scoring, and message generation. Static templates or fixed rule sets are typically used to generate messages, which do not scale well when additional contextual factors or user preferences are introduced. This results in suboptimal utilization of processing resources, because large parts of the system must be redesigned or recomputed when new conditions or factors are added.

Third, conventional systems do not leverage feedback loops at the level of the prompt formulation fed to a generative artificial intelligence model. Even when user feedback is collected, it is often used only for coarse-grained model retraining or simple preference flags, without directly updating the internal rules for computing visit suitability or the structure of the prompt sentences that drive the behavior of the generative model. This leads to a technical limitation in that the server is not able to adjust the input space of the generative model in a fine-grained manner, thereby failing to efficiently adapt to user preferences. As a result, computational resources in the server and external artificial intelligence infrastructure are not optimally used, because many generated messages are poorly aligned with user expectations and are discarded or ignored.

Fourth, when conventional systems interact with generative artificial intelligence models, the construction of prompts is often ad hoc and not treated as a formal, updatable software component with stateful parameters. This prevents the server from using structured internal representations, such as visit suitability scores and reasoning text fragments, to systematically control the generative model's output. Consequently, the server cannot consistently encode the underlying decision logic, the ranking criteria, or the user's historical evaluation in the prompt sentence. This causes a technical deficiency in the controllability and predictability of the output of the generative model, and complicates debugging and optimization of the server-side software.

Accordingly, there is a need for a server-side system that: (i) programmatically acquires and normalizes heterogeneous external data related to locations, schedules, weather, and congestion; (ii) computes visit suitability scores in a structured and extensible manner; (iii) constructs prompt sentences that explicitly encode both the computed scores and user-specific preference and evaluation history; and (iv) uses user feedback to update both the scoring rules and the prompt generation conditions, thereby adaptively controlling the behavior of a generative artificial intelligence model. Such a system should improve the efficiency, adaptability, and maintainability of the computer-based recommendation process and provide a more technically robust integration between deterministic data processing components and generative models.

The specific processing by the specific processing unit 290 of the data processing device 12 in Example 2 is realized by the following means.

The present invention provides a server comprising a processor configured to acquire, via a communication interface, information on target locations that a user desires to visit from an external information sharing service, and to store extracted location attributes in a storage device; to acquire schedule information of the user from an external schedule management service and compute free time periods within a predetermined period; to acquire weather information and occupant number information corresponding to combinations of the free time periods and the target locations from external information providing services, and compute a visit suitability score for each target location by quantifying visit suitability based on the weather information and the occupant number information; to select visit candidate locations and visit candidate time periods based on the visit suitability scores and preference information of the user; to generate a prompt sentence including an explanation text of the selection results, past evaluation information of the user, and information on preference tendencies of the user, and to supply the prompt sentence as input data to a generative artificial intelligence model; to obtain a response message from the generative artificial intelligence model, extract a visit proposal message from the response message, and store the visit proposal message; to transmit the visit proposal message to a terminal device; and to acquire, from the terminal device, evaluation information and feedback information of the user regarding the visit proposal message, update a calculation rule of the visit suitability score and a generation condition of the prompt sentence based on the evaluation information and the feedback information, and adjust content of subsequent prompt sentences input to the generative artificial intelligence model according to the updated generation condition. This enables the server to implement an adaptive, feedback-driven recommendation pipeline in which deterministic data acquisition and scoring modules are tightly integrated with prompt-controlled generative processing, thereby improving the efficiency, controllability, and maintainability of computer resources used for generating personalized visit proposals, and enhancing the technical performance of the overall recommendation system.

The term “processor” refers to a hardware or virtual computing unit, such as a central processing unit or a virtual machine, configured to execute instructions and perform arithmetic, logic, control, and input/output operations according to software programs.

The term “storage device” refers to a hardware component or logical resource, such as a memory device or a database system, configured to store, maintain, and retrieve data used or generated by the processor.

The term “communication interface” refers to a hardware or software component, such as a network interface controller or a communication module, configured to send data to and receive data from external devices or services via a communication network.

The term “external information sharing service” refers to an information processing system or platform, provided by an entity different from the server, that stores and supplies user-generated or user-related content including location-related information, and that is accessible via a communication network using an application programming interface.

The term “external schedule management service” refers to an information processing system or platform, provided by an entity different from the server, that manages user schedule information such as events and appointments, and that is accessible via a communication network using an application programming interface.

The term “external information providing service” refers to an information processing system or platform, provided by an entity different from the server, that supplies environmental information such as weather information or congestion-related information, and that is accessible via a communication network using an application programming interface.

The term “target location” refers to a geographical point or area, such as a facility, landmark, or region, that can be associated with a position on the earth and that is a candidate destination for a user's visit.

The term “location attribute” refers to data associated with a target location, including at least one of a location name, a position coordinate, a category, a classification, or an identifier used by an external service.

The term “schedule information” refers to data representing planned time periods for activities of a user, including start times, end times, dates, and descriptive information relating to events or appointments.

The term “free time period” refers to a time interval within a predetermined period during which no scheduled event or appointment is registered for the user in the schedule information.

The term “weather information” refers to data representing meteorological conditions associated with a target location and a time, including at least one of a weather condition classification, a temperature value, a precipitation probability, or a precipitation amount.

The term “occupant number information” refers to data representing an estimated or measured level of presence of persons at a target location, including at least one of a numeric congestion score, a congestion category, or an occupancy level.

The term “visit suitability score” refers to a numerical or ordinal value computed by the processor, representing a degree of suitability for a user to visit a target location at a particular time, based on at least the weather information and the occupant number information.

The term “preference information of the user” refers to data that represents tendencies or likes and dislikes of a user regarding visit conditions, such as preferred time of day, preferred congestion level, or preferred environmental conditions.

The term “past evaluation information of the user” refers to data representing explicit or implicit assessments by the user regarding previously presented proposal messages or previously executed visits, including ratings, selections, or feedback responses.

The term “preference tendency information of the user” refers to data derived from analysis of the past evaluation information of the user, representing patterns in the user's behavior or evaluations, such as a tendency to favor low congestion or specific time ranges.

The term “prompt sentence” refers to a text or structured sequence of tokens generated by the processor, including contextual information, reasoning information, and instructions, and supplied as input to a generative artificial intelligence model to control generation of an output message.

The term “generative artificial intelligence model” refers to a software-based inference model, such as a neural network model, trained on data to generate text or other content in response to input data including a prompt sentence.

The term “response message” refers to output data generated by the generative artificial intelligence model in response to a supplied prompt sentence and received by the processor.

The term “visit proposal message” refers to text or structured data extracted from the response message, representing a recommendation to a user to visit at least one target location at at least one time period, including associated reasons or context.

The term “terminal device” refers to an information processing apparatus operated directly or indirectly by a user, such as a mobile device, a portable terminal, or a client computer, configured to communicate with the server and to present information to the user.

The term “evaluation information” refers to data indicating a user's assessment of a visit proposal message, including at least one of a rating value, a selection result, or a binary indication such as acceptance or rejection.

The term “feedback information” refers to data provided by a user in response to a visit proposal message, including free-form text, selections, or interaction logs, used to infer or update user preferences or system performance.

The term “calculation rule of the visit suitability score” refers to a set of parameters, functions, or conditions used by the processor to compute the visit suitability score from input variables including the weather information, the occupant number information, and optionally user preference information.

The term “generation condition of the prompt sentence” refers to a set of parameters, templates, or structural rules used by the processor to determine which elements of contextual information, reasoning information, and user-related information are included in the prompt sentence and how they are arranged.

In an embodiment, a server provides a recommendation system that proposes visit timings and destinations to a user by integrating heterogeneous external data sources and by controlling a generative AI model through structured prompt sentences. The server is implemented, for example, on a general-purpose computer such as an x86_64 server executing an operating system such as a UNIX-based server operating system. The server includes at least a processor, a main memory, a persistent storage device, and a network interface. The server executes application software implemented in a general-purpose programming language such as a scripting language and uses libraries for network communication, data processing, and access to external services and AI inference services.

The server stores application logic and data in a non-transitory computer-readable storage device such as a magnetic disk, a solid-state drive, or a distributed database system. The server uses a relational database management system, such as a general-purpose SQL database, as a storage device for structured data. Tables stored in the database include at least a user account table, a desired place table, an available slot table, a candidate visit table, a weather forecast table, a congestion forecast table, a proposal table, a feedback table, and a user preference table. Each table has a defined schema, for example: the desired place table includes columns for a user identifier, a location identifier, a location name, a latitude, a longitude, and a category; the available slot table includes a user identifier, a start time, an end time, and a time zone identifier.

The server communicates with external information sharing services, external schedule management services, and external information providing services through a network interface using standardized protocols such as HTTPS. The server uses application programming interfaces provided by those external services to obtain structured data in formats such as JSON. For example, the server accesses a social content platform through an application programming interface, retrieves user-tagged locations marked as “want to go,” and parses the returned structured data.

The server uses a schedule management service application programming interface to access the user's calendar. The server retrieves event objects including start times, end times, and descriptions. The server performs arithmetic operations on time data, such as merging overlapping time intervals and subtracting busy intervals from an overall weekend interval, in order to compute free time periods. These operations are executed in the processor using internal data structures such as arrays or lists of interval objects. The server stores the resulting free time periods in the available slot table.

The server uses a weather information service to obtain weather forecasts for specific coordinates and times. The server sends requests including latitude, longitude, and forecast time, and receives JSON responses including weather condition codes, temperature values, and precipitation probabilities. The server transforms the received data into normalized internal representations, for example mapping external weather codes to an internal set of status values such as CLEAR, CLOUDY, RAIN, and STORM. The server also uses a congestion or occupancy information service to obtain predicted or measured congestion levels at the same coordinates and times, receiving data such as numeric congestion scores or categorical congestion levels such as LOW, MEDIUM, and HIGH. The server normalizes these values into internal congestion levels.

The server computes a visit suitability score for each combination of a target location and a free time period by applying a scoring function implemented as a deterministic algorithm executed by the processor. The scoring function uses as input features at least: normalized weather status, temperature, precipitation probability, normalized congestion level, duration of the free time period, and optionally historical preference indicators of the user. The scoring function applies weighted arithmetic operations and conditional logic. For example, the server may assign base points to each candidate, add a weather bonus if weather status is CLEAR or CLOUDY with low precipitation, subtract a penalty if congestion level is HIGH, and add preference-based modifiers if the time period corresponds to a user-preferred time of day. The server stores the computed visit suitability score in the candidate visit table in association with the location identifier and the time period.

The server selects visit candidate locations and visit candidate time periods based on the visit suitability scores and user preference information. The server retrieves rows from the candidate visit table and orders them by the visit suitability score. The server applies a threshold or ranking rule to select a limited number of candidates, for example the top several candidates. The server then prepares internal reasoning text data for each selected candidate. The reasoning text data includes, for example, explicit mentions of the main factors that contributed to the score: “clear weather,” “low congestion,” “sufficient duration,” “preferred evening time,” and so on. The server generates the reasoning text by concatenating predefined phrase segments according to the internal state of the scoring function. This internal generation of reasoning text ensures that the prompt sentence supplied to the generative AI model is tightly coupled with the underlying deterministic decision process.

The server generates a prompt sentence as a text sequence, which includes contextual information about the user, the selected locations, the selected time periods, the weather and congestion conditions, and the reasoning for the selection, as well as past evaluation information and preference tendencies of the user. The server uses string templates and conditional insertion of phrases to assemble the prompt sentence. The prompt sentence not only describes the recommended option, but also encodes explicit instructions to the generative AI model regarding style, length, and constraints of the output.

For example, the server may generate a prompt sentence such as:

“The user has marked ‘Tokyo Tower’ as a place they want to visit.

The user is free next weekend on Saturday from 13:00 to 18:00.

Weather forecast for Tokyo Tower on Saturday afternoon: clear sky, comfortable temperature, no rain expected.

Congestion forecast for Tokyo Tower at that time: low congestion.

The user generally prefers times with fewer crowds and has rated previous recommendations higher when they emphasize relaxing atmospheres and scenic views.

Based on this information, use a generative AI model to create a short, friendly recommendation message for the user. The message should:
suggest visiting Tokyo Tower on Saturday afternoon,
mention the good weather and low congestion as reasons,
emphasize a relaxed atmosphere and scenic views,
be written in English,
be 100-150 words long,
address the user as ‘you’.
Draft only the final message text.”

The server supplies the prompt sentence to a generative AI model. In one embodiment, the generative AI model is a neural network language model with a transformer architecture. The generative AI model comprises multiple layers of self-attention and feed-forward sublayers, each with trainable weight matrices. The model is pre-trained on large corpora of text data using a self-supervised learning method such as next-token prediction, where the model learns to predict the next token in a sequence given previous tokens. During training, the model computes loss values, such as cross-entropy loss between predicted token probabilities and ground-truth tokens, and updates internal weights by backpropagation and gradient-based optimization methods such as stochastic gradient descent or adaptive gradient methods.

The server uses the generative AI model in an inference mode by passing the prompt sentence as an input sequence of tokens. The generative AI model computes internal contextual representations through its transformer layers, applies attention mechanisms that weigh different parts of the input prompt sentence, and outputs a probability distribution over possible next tokens at each generation step. The server configures generation parameters such as temperature, maximum number of output tokens, and sampling method. The server then receives the generated response message as a sequence of tokens. Because the server constructs the prompt sentence with structured and stateful information about scoring and reasoning, the behavior of the generative AI model is more controlled and the resulting output is more predictable and aligned with the server's internal decision logic.

The server parses the response message received from the generative AI model and extracts a visit proposal message for the user. The server may define delimiters or structural markers in the prompt sentence so that only a specific portion of the output is used as the visit proposal message. The server stores the visit proposal message in the proposal table, associated with the user identifier, the candidate visit parameters, the prompt sentence used, and the model parameters that were applied. The server then transmits the visit proposal message to a terminal device via the network. The terminal may be a smartphone, a tablet, or another client device. The server uses a push notification service or a direct communication protocol to deliver a notification containing at least a summary of the visit proposal message. The terminal displays the visit proposal message on a graphical user interface and allows the user to read the full text.

The user reads the proposal and may provide evaluation information and feedback information through the terminal. The terminal transmits the user's evaluation information, such as a rating value, a binary helpfulness flag, and optional free-text comments, back to the server. The server receives and stores this feedback in the feedback table. The server then analyzes the feedback data using statistical operations and optional machine learning procedures. For example, the server calculates average ratings for different ranges of congestion levels, different times of day, or different wording patterns of messages. The server updates the user preference table with new preference tendencies, such as an increased preference for low congestion during afternoons, or a preference for shorter messages.

The server also updates calculation rules of the visit suitability score based on aggregated feedback. The server adjusts weight parameters in the scoring function, such as increasing the penalty for high congestion for a user who consistently evaluates crowded-time recommendations as unhelpful. This adjustment is done using arithmetic operations on stored weight values. The server further updates generation conditions of the prompt sentence, such as including more emphasis on scenic views if the user frequently mentions views in positive comments. These updates generate a feedback loop in which the server's internal scoring algorithm and prompt generation logic are modified as the user interacts with the system.

This feedback-driven adjustment of the scoring function and prompt generation logic yields several technical effects. First, because the scoring function parameters are individualized based on actual user feedback, the server can reduce the number of candidate visits that are likely to be rejected, thereby decreasing the frequency of unnecessary requests to external information services and the generative AI model. This reduces network traffic and inference load, which in turn reduces processing time and resource consumption. Second, by encoding the updated preferences and reasoning explicitly in the prompt sentence, the server improves the alignment between the generative AI model's output and the underlying deterministic logic, which increases the accuracy of proposals and decreases the need for manual correction or additional computation at the client side. Third, the structured handling of prompt generation as a configurable software component allows the server to modify behavior by adjusting data and configuration stored in the database, rather than by redeploying application code. This improves maintainability and extensibility of the system.

The server executes these operations using non-conventional, non-generic usage of the generative AI model. Instead of merely replacing a human writer with automated text generation, the server uses the generative AI model as a controlled component within a broader algorithmic pipeline that combines deterministic scoring and explicit reasoning encoding. The prompt generation logic creates an intermediate data structure—a structured prompt sentence—that acts as a bridge between numerical scoring output and natural language reasoning. This design is different from conventional systems that either rely solely on rule-based templates or use an AI model without explicit control of prompt composition.

The server uses internal features such as visit suitability scores, user preference vectors, and time-of-day indicators, which are not directly accessible to a human operator, to shape the content and tone of the prompt sentence. This results in an improvement to computer technology itself by enabling more efficient and controllable use of computational resources for content generation.

In another embodiment, the server uses an internal machine learning module in addition to the generative AI model. The server may implement a lightweight neural network, such as a feed-forward network, that learns to predict user ratings from features derived from candidate visits, including weather, congestion, time of day, travel distance, and previous rating history.

The server uses a loss function such as mean squared error between predicted ratings and actual ratings collected in the feedback table, and updates weights using gradient descent.

The output of this predictive model may be used as an additional factor in computing the visit suitability score or in selecting which candidates should be promoted to prompt sentences.

This allows the server to further refine candidate selection without changing the generative AI model itself, thereby reducing the number of calls to the generative AI model and improving overall throughput.

In a variation, the server may use different generative models for different tasks. For example, one model may be specialized in generating concise summaries, while another may generate detailed explanations. The server chooses which model to call based on internal configuration and user preference data. The server can also adjust generation parameters such as maximum token counts to reduce communication payload sizes in low-bandwidth environments, thereby decreasing communication overhead. In another variation, the server can cluster user feedback to identify groups of users with similar preferences and apply cluster-level scoring rules and prompt templates, which reduces the computational effort of updating per-user parameters while still personalizing proposals beyond generic defaults.

The terminal may also provide additional context data to the server, such as the user's current location or device status, which can be used by the server to refine scoring and prompt generation. For example, if the current device location indicates that the user is already near a particular target location, the server can update the scoring function to favor nearby locations and modify the prompt sentence to mention the current proximity as a reason for the recommendation. This dynamic integration of real-time context data further demonstrates that the system is not a static business rule automation, but a technical method for improving computer-based recommendation behavior.

The user interacts with the system by granting access permissions, reviewing proposals, and providing feedback. The user does not need to manually gather and integrate weather forecasts, congestion predictions, and schedule information; instead, the server performs these integrations at machine speed with consistent algorithms, reducing human error and latency. However, the core of the invention lies not in the automation of user activities per se, but in the structured, feedback-driven integration between deterministic scoring modules and generative AI models via expressly designed prompt sentences and data structures. This integration produces measurable improvements in processing efficiency, proposal accuracy, and system maintainability, and thus constitutes a technical improvement in computer-based recommendation systems.

Various modifications and alternatives can be applied to the described embodiments. For example, different types of external data sources can be used, such as transportation status information or environmental quality indicators. Different scoring functions, weighting schemes, and neural network architectures, such as recurrent networks or convolutional networks, can be adopted depending on the target environment. The essential aspect is that the server computes structured internal representations (including visit suitability scores and reasoning components), generates prompt sentences that explicitly incorporate those representations, and uses user feedback to update both the scoring rules and the prompt generation conditions, thereby controlling the behavior of the generative AI model in a manner that improves the technical performance of the overall system.

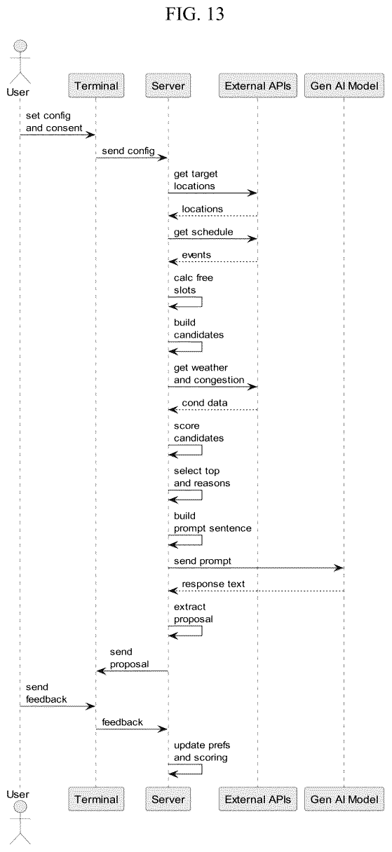

The following describes the processing flow using FIG. 13.

### Step 1:

Server receives user configuration and consent information from terminal.

Server takes as input user identifiers, access tokens for external services, user consent flags, and initial preference settings transmitted from terminal. Server validates the structure and consistency of the input, then writes normalized records into internal tables such as a user account table and a user preference table. Based on the input, server registers which external information sharing services, external schedule management services, and external information providing services will be accessed for this user.

### Step 2:

Server acquires target location information from external information sharing service.

Server takes as input the user identifier and stored access credentials for the external information sharing service. Server sends authenticated requests through a communication interface to the external service's application programming interface to obtain structured data regarding locations that user has marked as desired to visit. Server parses the received data, extracts standardized location attributes such as location name, coordinates, and category, and outputs normalized records which are stored in a desired place table.

### Step 3:

Server acquires schedule information and computes free time periods.

Server takes as input the user identifier, schedule service credentials, and a target time range such as the next weekend. Server requests event data from an external schedule management service and receives a list of events including start time and end time. Server converts the event list into internal time-interval objects, merges overlapping intervals, and subtracts these busy intervals from the overall target time range. Server outputs free time periods as a set of non-overlapping time intervals, and stores them in an available slot table.

### Step 4:

Server generates candidate visit combinations from locations and free time periods.

Server takes as input the set of target locations from the desired place table and the set of free time periods from the available slot table. Server forms candidate pairs by associating each target location with each free time period, subject to constraints such as minimum visit duration. Server filters out combinations where the free time period is shorter than a threshold. Server outputs candidate visit records containing a location identifier and a corresponding time interval, and stores them in a candidate visit table.

### Step 5:

Server acquires weather information for candidate visits.

Server takes as input candidate visit records, each including coordinates and time interval.

For each candidate, server determines a representative time such as the midpoint of the interval and sends a request to an external weather information service including the coordinates and representative time. Server receives weather forecasts, parses meteorological fields such as condition code, temperature, and precipitation probability, and converts them into internal weather status values. Server outputs normalized weather forecast records linked to candidate visit identifiers and stores them in a weather forecast table.

### Step 6:

Server acquires congestion information for candidate visits.

Server takes as input the same candidate visit records, including location identifiers and time intervals. Server maps each location identifier to an external place identifier used by a congestion information service. Server sends requests to the external information providing service with the place identifier and the time interval. Server receives congestion-related data such as numeric congestion scores or level categories, normalizes the values into standardized levels such as LOW, MEDIUM, and HIGH, and outputs congestion forecast records which are stored in a congestion forecast table.

### Step 7:

Server computes visit suitability scores based on weather, congestion, and user preferences.

Server takes as input candidate visit records, associated weather forecasts, associated congestion forecasts, and user preference data from the user preference table. Server applies a scoring algorithm in which the processor calculates a base score for each candidate and modifies the score by adding bonuses or penalties according to weather status, congestion level, duration of the time interval, and matching with user preferences such as preferred time of day or crowd level. Server outputs a numerical visit suitability score for each candidate visit and updates the candidate visit table to include the computed scores.

### Step 8:

Server selects top visit candidates and generates internal reasoning text.

Server takes as input the candidate visit records including visit suitability scores. Server ranks the candidates by score, applies a selection rule such as picking the top few candidates, and filters out lower-ranked options. For each selected candidate, server inspects contributing factors recorded during scoring, such as GOOD weather or LOW congestion, and generates structured reasoning text by concatenating predefined phrase segments corresponding to each factor. Server outputs a set of selected visit candidates and associated reasoning text fragments, and stores them in the proposal-related data structures.

### Step 9:

Server constructs a prompt sentence for the generative AI model.

Server takes as input selected visit candidates, corresponding reasoning text, past evaluation information of user, and preference tendency information from the user preference table.

Server assembles these inputs into a single coherent prompt sentence using text templates and conditional insertion rules. Server inserts, for each selected candidate, the location name, recommended time interval, weather description, congestion description, and explicit reasoning phrases, and also includes instructions about output length, language, and tone.

Server outputs a complete prompt sentence as a text sequence ready to be supplied to the generative AI model.

### Step 10:

Server inputs the prompt sentence to the generative AI model and obtains a response message.

Server takes as input the constructed prompt sentence and configuration parameters such as maximum output length and sampling temperature. Server converts the prompt sentence into tokens and transmits them to the generative AI model through an inference interface. The generative AI model processes the prompt sentence using its internal neural network layers and outputs a sequence of tokens representing a response message. Server receives the token sequence, decodes it into text, and outputs the response message for downstream processing.

### Step 11:

Server extracts a visit proposal message from the response message and stores it.

Server takes as input the response message text generated by the generative AI model. Server optionally identifies delimiters or boundaries within the text if defined by the prompt specification, trims irrelevant sections, and isolates the portion that constitutes the visit proposal message addressed to user. Server associates the proposal message with the corresponding candidate visit identifiers and prompt sentence, and stores the proposal message in a proposal table as an output ready to be transmitted to terminal.

### Step 12:

Server sends the visit proposal message to terminal.

Server takes as input the stored proposal message and the user's device identifiers or communication endpoints. Server constructs a transmission payload including at least the main part of the proposal message and optional summary elements such as a title or short preview. Server uses a push notification service or other communication protocol to send the payload through the network to terminal. Terminal receives the payload and outputs a notification or displays the full text on a user interface for user.

### Step 13:

User reviews the visit proposal message and provides feedback via terminal.

User reads the visit proposal message presented on terminal and optionally inputs evaluation information such as a rating, a helpfulness flag, and comments. Terminal collects these user inputs as structured data and transmits them to server over the network. The output of this step is feedback data including references to the proposal message and to the user, which becomes input for subsequent server-side adaptation.

### Step 14:

Server records user feedback and updates internal preference and scoring data.

Server takes as input the feedback data received from terminal, including proposal identifiers, rating values, and text comments. Server stores the feedback records in a feedback table and performs data analysis operations such as computing averages, counting positive and negative responses, and identifying patterns in comment text. Based on the analysis, server updates user preference parameters in the user preference table and adjusts weight values or thresholds in the visit suitability scoring rules. Server outputs updated scoring parameters and updated preference profiles, which will be used as input in future executions of Steps 7 through 9 to refine visit suitability scores and prompt sentence generation for the generative AI model.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional visit-recommendation and planning systems typically combine a limited set of static factors, such as basic calendar availability and coarse weather conditions, to present suggested locations or times to a user. These systems generally rely on fixed rule sets or simple scoring functions executed by a processor. As a result, such systems exhibit several technical shortcomings when implemented on computer hardware.

First, because conventional systems do not tightly integrate heterogeneous data sources in a unified processing pipeline, including schedule data, environment data such as detailed weather and congestion, user preference histories, and user emotional states, a processor must often execute multiple independent routines and store redundant intermediate data structures.

This leads to inefficient memory access patterns, increased latency in generating recommendations, and poor scalability when the volume of users or external data sources increases.

Second, existing systems that merely invoke external machine learning services or recommendation engines typically treat those services as black boxes and do not generate structured, context-rich input instructions. Without a dynamically constructed prompt sentence that encodes current schedule constraints, multi-dimensional environment conditions, and user-specific historical and emotional information, the generative AI model produces outputs that are either too generic or inconsistent with real-world constraints. This results in additional post-processing and filtering on the server side, further increasing processor load and response time.

Third, conventional systems rarely feed back granular user evaluation and emotional reaction data into the underlying models in a systematic way. Even when user ratings or comments are stored, they are often not transformed into quantitative emotion feature values that can be used to update model parameters or evaluation indices. Consequently, the processor repeatedly applies the same static algorithms, which degrades recommendation quality over time and prevents the system from adapting to changes in user behavior or environmental patterns.

Fourth, because prior solutions do not dynamically adjust both the internal scoring logic and the generative AI interaction based on real-time emotional state, the processor cannot optimize the selection and ordering of candidate visit times and locations in a way that reduces unnecessary model calls, avoids evaluation of unsuitable candidates, and minimizes wasted computations. This leads to suboptimal utilization of processing resources and network bandwidth between the server and external AI services.

Therefore, there is a need for an improved computer-implemented system and method in which a processor: (i) acquires and integrates schedule information, environment information, user preference information, behavior history information, and emotional state information in a unified data model; (ii) generates structured prompt sentences tailored to a generative AI model on the basis of computed evaluation indices; and (iii) performs iterative relearning and parameter updating using emotion feature values derived from user feedback. Such a system should improve the technical efficiency and effectiveness of the recommendation pipeline itself, resulting in lower processing overhead, reduced latency, and higher-quality, constraint-consistent proposals generated by the computing platform.

The specific processing by the specific processing unit 290 of the data processing device 12 in Application Example 2 is realized by the following means.

The present invention provides a server comprising a processor, a storage device, and an output device, the processor being configured to execute instructions that cause the processor to store visit-target information indicating a location that a user wishes to visit in the storage device, to acquire schedule information of the user by synchronizing with a schedule management function, to acquire environment information including weather information and congestion information from an external information providing function, to integrate the schedule information, the weather information, and the congestion information to generate candidate visit times and candidate visit locations, to acquire preference information of the user, past behavior history information of the user, and emotional state information of the user from the storage device and calculate an evaluation index by associating the preference information, the past behavior history information, and the emotional state information with the candidate visit times and the candidate visit locations, to generate a prompt sentence for instructing a generative AI model to generate proposal content on a basis of the integrated information and the evaluation index, to input the prompt sentence to the generative AI model and acquire, from the generative AI model, a proposal result and explanation information relating to at least one of the candidate visit times and the candidate visit locations, to present the proposal result to a user terminal via the output device, to acquire evaluation information and feedback information from the user terminal regarding the proposal result and perform emotion analysis processing on the evaluation information and the feedback information to extract emotion feature values, and to perform, on a basis of the emotion feature values and the evaluation information, a relearning process for the generative AI model and a parameter updating process for calculation of the evaluation index so as to update internal model parameters stored in the storage device. This enables the computing platform to implement an integrated, feedback-driven recommendation pipeline in which heterogeneous data sources are fused into a unified evaluation framework, context-rich prompt sentences are automatically generated and supplied to the generative AI model, and the resulting proposal quality and computational efficiency are iteratively improved through emotion-aware relearning and parameter updates, thereby reducing processing overhead, lowering response latency, and increasing the relevance and constraint-consistency of recommendations produced by the server.

The term “processor” refers to a hardware processing unit, such as a central processing unit or a computing core, that executes machine-readable instructions to perform arithmetic, logic, control, and data processing operations of the system.

The term “storage device” refers to a hardware memory component, such as a semiconductor memory or a magnetic storage apparatus, configured to store data, models, parameters, and program instructions used by the processor.

The term “output device” refers to a hardware interface component, such as a display interface, a communication interface, or a notification interface, through which the system transmits information, including proposal results, to an external device such as a user terminal.

The term “user terminal” refers to an external computing apparatus operated by a user, such as a portable communication device or a personal computing device, that exchanges data with the system and presents information to the user.

The term “visit-target information” refers to data indicating a physical or virtual destination that the user wishes to visit, including abstract identifiers, geographic identifiers, or category identifiers of the destination.

The term “schedule information” refers to data representing temporal availability and planned activities of the user, obtained from a schedule management function, including time ranges classified as occupied or free.

The term “schedule management function” refers to a software-based time management service or application that maintains event records and provides an interface for querying and updating the user's scheduled activities.

The term “environment information” refers to data indicating external conditions relevant to a visit, including but not limited to meteorological conditions and crowding conditions of a region or facility.

The term “weather information” refers to environment information specifying atmospheric conditions such as precipitation, temperature, wind, and sky conditions for a given place and time interval.

The term “congestion information” refers to environment information indicating a level of crowding, occupancy, traffic density, or service load at a given place and time interval.

The term “external information providing function” refers to a network-accessible service or interface that supplies environment information or other data to the system via a communication protocol.

The term “candidate visit time” refers to a time or time interval computed by the processor as a possible time for the user to visit a visit target, based on schedule information and environment information.

The term “candidate visit location” refers to a visit target or a geographic area selected by the processor as a possible location for a visit, based on visit-target information and environment information.

The term “preference information” refers to data representing long-term or short-term preferences of the user, including favored categories of places, activities, or conditions inferred from explicit settings or historical behavior.

The term “past behavior history information” refers to data indicating historical actions of the user related to visits, such as previously visited locations, visit times, and user responses to past proposals.

The term “emotional state information” refers to data indicating a current or past emotional condition of the user, such as stress level, joy, or relaxation, derived from explicit input or analysis of user signals.

The term “evaluation index” refers to a numerical or symbolic metric calculated by the processor to represent a suitability or preference score of each candidate visit time and candidate visit location.

The term “prompt sentence” refers to a machine-generated textual instruction or query provided as input to a generative AI model, the instruction encoding integrated schedule, environment, preference, history, and emotional information for generating proposal content.

The term “generative AI model” refers to a trained machine learning model, such as a sequence generation model or language model, that produces proposal content or explanatory text in response to a prompt sentence.

The term “proposal content” refers to output data produced by the generative AI model or by the processor that specifies at least one recommended candidate visit time or candidate visit location, optionally together with justification.

The term “proposal result” refers to a concrete instance of proposal content selected for presentation to the user, including a designated time, a designated location, and associated metadata.

The term “explanation information” refers to text or structured data describing reasons, constraints, or conditions that support a proposal result and are presented to the user as part of the recommendation.

The term “evaluation information” refers to data indicating an assessment by the user of a proposal result or an actual visit, including ratings, selections, and other explicit evaluation inputs.

The term “feedback information” refers to data obtained from the user after receiving or using a proposal result, including textual comments, interaction logs, or other qualitative or quantitative responses.

The term “emotion analysis processing” refers to computation performed by the processor or an associated module to derive emotion-related measures from evaluation information, feedback information, or user signals.

The term “emotion feature values” refers to quantitative or categorical values representing emotional characteristics, such as sentiment scores or emotion labels, extracted by emotion analysis processing.

The term “relearning process” refers to a process in which parameters of the generative AI model are updated or fine-tuned using newly obtained data, including emotion feature values and evaluation information, so as to change subsequent outputs of the model.

The term “parameter updating process for calculation of the evaluation index” refers to a process in which weighting factors, thresholds, or other algorithmic parameters used to compute the evaluation index are adjusted based on emotion feature values and evaluation information.

The term “information sharing function interface” refers to a programmatic interface to a communication or social information service through which the system acquires data that has been marked or posted by the user as representing a desired visit.

The term “location information that has been marked as a desired visit” refers to data obtained via the information sharing function interface that indicates a destination identified by the user as a place the user wishes to visit.

The term “text information” refers to character-based data such as natural language sentences, keywords, or labels provided by or derived from user input or external sources.

The term “voice information” refers to audio data or parameters derived from audio signals representing spoken utterances by the user.

The term “image information” refers to visual data or parameters derived from visual signals representing user facial expressions or other visual cues.

The term “emotion analysis function” refers to a software or hardware component that processes text information, voice information, or image information to estimate an emotional state of the user.

The term “priorities of the candidate visit times and the candidate visit locations” refers to ordering or weighting information used by the processor to rank, select, or filter candidate visit times and candidate visit locations for proposal generation.

In one embodiment, a server, a terminal, and a user cooperate to implement the claimed system. The server includes at least one processor, a main memory, a non-volatile storage device, and a network interface. The storage device stores application programs, trained model parameters, prompt-generation rules, and various data tables. The terminal includes a processor, a display unit, an input unit, a location sensor, and a communication interface. The terminal executes an application that communicates with the server over a network such as the Internet.

The server executes an operating system and a server application. The server application is implemented, for example, on a general-purpose web framework and exposes application programming interfaces to the terminal and to multiple external data-providing services. The server application manages a database management system, such as a relational database engine, configured to store visit-target information, user schedule information, environment information, preference information, behavior history information, and emotional state information.

The server uses a modular architecture in which different logical modules are executed by the processor. The server includes a data acquisition module, a feature extraction module, a scoring module, a prompt-generation module, a generative AI interaction module, an emotion analysis module, a model training module, and a recommendation presentation module. Each module uses clearly defined input and output data structures stored in the storage device. For example, the data acquisition module writes records into tables for visit targets, schedule slots, weather forecasts, congestion estimates, feedback entries, and emotion features.

The terminal provides a graphical user interface to the user. The user operates the terminal to indicate locations that the user wishes to visit and to provide explicit emotional input. For example, the user selects a location on a map displayed on the terminal or chooses a previously stored location from a list. The terminal then transmits visit-target information to the server, including a user identifier, a target identifier, and optionally a text label entered by the user. The terminal also transmits location information obtained from the location sensor so that the server can associate visit targets with geographic coordinates stored in the database.

The server stores visit-target information in a table where each record contains at least a user identifier, a target identifier, a category, a geographic coordinate pair, and a timestamp. The server normalizes incoming data by assigning internal identifiers and by classifying the targets into coarse categories, such as “food service facility,” “park,” or “shopping facility.”

This structured representation allows the scoring module and prompt-generation module to operate on compact identifiers rather than on large chunks of unstructured text, thereby improving cache locality and reducing memory usage in the processor.

The server acquires schedule information of the user by synchronizing with a schedule management function. The terminal or the server accesses a calendar service via an application programming interface and retrieves event data within a predetermined time range. The server converts the raw event list into a schedule grid representation. For example, the server discretizes time into fixed-size slots, such as 15-minute or 30-minute intervals, and assigns each slot a state value that indicates whether the slot is free or occupied. The schedule grid is stored in a table where each row corresponds to a user, a date, a slot index, and a state value. By using the schedule grid, the scoring module can efficiently compute candidate visit times via sequential array operations instead of repeatedly scanning raw event records, thereby reducing computational complexity.

The server acquires environment information, including weather information and congestion information, via external information providing functions. For weather information, the server calls a weather data service and receives structured data for temperature, precipitation, and general conditions indexed by time and location. The server maps the raw weather measurements into normalized scores, such as a comfort score and a precipitation penalty score, which are stored as numerical attributes linked to time slots and locations. For congestion information, the server calls external services that estimate crowding levels based on historical data, sensor data, or traffic patterns. The server transforms provider-specific data formats into a unified congestion score in the range of 0 to 1. The environment information is thus stored in compact numeric form suitable for vectorized operations.

The server acquires preference information and past behavior history information of the user from the storage device. The server maintains a user profile that aggregates statistics over time, such as the frequency of visits to each category of location, average satisfaction scores for different categories, and typical time-of-day preferences. The server constructs feature vectors representing the user profile, including category preference weights, time-of-day distribution parameters, and environment tolerance parameters, such as preferred range of congestion or acceptable weather conditions.

The server acquires emotional state information of the user through multiple channels. The user may directly enter textual descriptions of emotional state using the terminal, such as “I feel stressed today” or “I am relaxed.” The terminal may also transmit voice data or image data, such as a selfie or a video snippet, which the server converts into features using separate signal-processing pipelines. The server stores raw emotional inputs and associates them with timestamps and contexts, such as recent visits or received recommendations.

The server performs emotion analysis processing on evaluation information and feedback information. The server applies a text-based emotion analysis function to user comments by tokenizing the text, mapping tokens to embeddings, and feeding the embeddings into a neural network classifier. The neural network classifier may be a multi-layer neural network including an embedding layer, several fully connected layers with non-linear activation functions, and an output layer that produces a probability distribution over emotion categories such as joy, stress, and disappointment. The server computes emotion feature values such as a sentiment score, a primary emotion label, and a confidence measure, and stores these values in the database.

The server optionally applies a separate model for voice-based or image-based emotion detection. For voice data, the server extracts acoustic features such as pitch, energy, and spectral descriptors using a digital signal processing module. The server then feeds the acoustic feature vectors into a recurrent neural network or a temporal convolutional neural network to classify emotional states. For image data, the server applies a convolutional neural network to estimate facial expression features and emotional states. The server fuses the results of multiple modalities using a weighted aggregation scheme to compute a unified emotional state representation. This multi-modal approach allows the server to capture emotional nuances that cannot be reliably inferred from text alone.

The server integrates schedule information, environment information, preference information, behavior history information, and emotional state information in a unified representation. The scoring module of the server creates a candidate set of time and location pairs. For each candidate, the server constructs a feature vector that includes time-slot features, location-category features, environment scores, and user-specific features. The server then computes an evaluation index for each candidate by applying a scoring function. The scoring function may be implemented as a parametric model such as a feedforward neural network or a gradient-boosted decision tree ensemble. The parameters of the scoring function are stored in the storage device and updated by the model training module.

The server uses the evaluation index to select a subset of candidates for further processing. By filtering out candidates with scores below a threshold, the server reduces the size of input for the generative AI model, which reduces network traffic and remote computation cost.

This candidate selection process is not a mere business rule, but a technical optimization of data flow that leads to lower processing latency and memory usage in the entire system.

The server generates a prompt sentence for instructing a generative AI model to generate proposal content. The prompt-generation module converts the selected candidate set and user profile into structured natural language. The server uses template structures that combine fixed phrases with dynamically inserted data fields, such as time ranges, environment descriptions, preference hints, and emotional context. For example, the server generates a prompt sentence such as:

“The user wants to order pizza this weekend. The user is free on Saturday from 5 PM to 9 PM and on Sunday from 12 PM to 3 PM. The weather will be sunny on Saturday evening and rainy on Sunday. The restaurant's predicted congestion is low at 6 PM on Saturday and high at 7 PM on Sunday. Based on these conditions and the user's preference for relaxed, not-crowded experiences, propose the best time to order pizza and explain your reasoning.”

In another example, when the user explicitly indicates a desired emotional outcome, the server generates a prompt sentence such as:

“The user currently feels stressed. Past feedback shows the user enjoyed quiet parks, hot springs, and riverside walks when stressed. Weather is clear this evening and congestion is low at Park A and moderate at Mall B. Propose one or two places and times to help the user relax tonight, and explain why.”

The server logs the prompt sentence in the storage device together with metadata about the context and selected candidates. This logging allows the model training module to later correlate the prompts with observed user outcomes, which supports automated improvement of prompt-generation rules and evaluation function parameters.

The server interacts with a generative AI model via a network interface. The generative AI model may be implemented as a large-scale language model hosted on a separate computing infrastructure. The server transmits the prompt sentence and receives a generated text response. The server specifies generation parameters such as maximum output length, sampling temperature, and output format. The generative AI model itself may use a transformer-based neural network architecture comprising multiple layers of self-attention and feedforward sublayers, trained on large-scale corpora. The parameters of the generative AI model are optimized using a training objective such as cross-entropy loss between predicted tokens and training tokens, with gradients propagated through the network and weights updated by a variant of stochastic gradient descent.

The server parses the generated text and extracts proposal content, such as selected candidate time slots and locations, together with explanation information. To reduce errors due to unconstrained natural-language output, the server optionally includes style constraints in the prompt sentence, such as instructing the model to output specific markers around times and locations. The parsing procedure generates structured proposal records that the server stores in the database.

The server presents the proposal result to the user terminal via the output device. The server includes in the response both machine-readable fields and human-readable explanations. The terminal displays cards or list items that show recommended times and locations, summary descriptions, and key reasons, such as “low congestion,” “good weather,” or “matches your past positive experiences.” By presenting concise, structured information, the terminal reduces the cognitive effort required by the user to compare alternatives, and the server reduces redundant network transfers by only sending the top proposals instead of all raw candidate data.

The user reviews the presented proposal and may accept or reject it, or may provide an explicit rating and a textual comment. The terminal transmits evaluation information and feedback information to the server. The server stores this information and triggers emotion analysis processing as described above. By systematically converting feedback into emotion feature values, the server builds a high-dimensional representation of user satisfaction patterns.

The server performs a relearning process for the generative AI model and a parameter updating process for calculation of the evaluation index. In one embodiment, the server uses a fine-tuning approach in which the server constructs training examples that pair prompt sentences with target outputs, such as the actual user-selected candidates or high-satisfaction proposals. The server defines a loss function, for example, a cross-entropy loss between the generative model's output probabilities and a target token sequence, or a ranking loss that penalizes the model when it assigns low probability to candidates that yielded high satisfaction. The server updates the model's parameters using gradient-based optimization.

Separately, the server updates the parameters of the scoring function used to compute the evaluation index. The server defines an objective function such as a mean squared error between predicted scores and realized satisfaction scores, or a pairwise ranking loss that encourages higher scores for candidates with higher user ratings. The server performs mini-batch gradient descent or a similar optimization method. By repeatedly adjusting the weights in response to new emotion feature values and evaluation information, the server adapts its internal selection logic to the user's evolving preferences and environmental patterns.

The server applies several technical optimizations that improve computer operation. For example, the server only invokes the generative AI model for a bounded number of high-scoring candidates, which reduces the number of remote calls and the size of each prompt sentence. The server compresses environment information into compact numeric features and uses these features in both the scoring module and the prompt-generation module. By structuring the data and processing pipeline in this manner, the server reduces memory bandwidth usage, minimizes the number of disk accesses, and improves cache utilization in the processor, which directly improves processing speed and throughput for large numbers of users.

In another embodiment, the server uses different neural network architectures for different sub-tasks. A relatively small model, such as a multilayer perceptron or a tree-based model, is used for the evaluation index calculation, while the large generative AI model is used only for natural-language proposal creation. This architectural separation allows the server to handle the majority of candidate filtering and ranking locally using computationally efficient models, while reserving the more resource-intensive generative AI calls for the top-ranked scenarios where natural-language explanations add value. This approach reduces network traffic and remote computation load, which is a technical improvement over systems that blindly send all raw context to a large model.

In a further embodiment, the server maintains different versions of scoring parameters and prompt templates for different groups of users or different device types. The server dynamically selects which configuration to apply based on device capabilities or network conditions. For example, when network latency is high, the server biases the evaluation index to select fewer candidates and reduces the amount of contextual detail in the prompt sentence to shorten the generative AI processing time. This dynamic adaptation improves responsiveness and reliability at the system level, which is a technical effect of the combination of modules and data structures.

The terminal may also implement local caching of previously received recommendation summaries. When the server indicates that a new proposal is similar to a past proposal, the terminal can reuse stored explanation text rather than requesting full details again, thereby reducing bandwidth usage. The server decides similarity based on hashed representations of candidate sets and user profiles.

Across these embodiments, the server does not merely automate a human decision-making process. Rather, the server rearranges the flow of data, the structure of candidate evaluation, the generation of prompt sentences, and the feedback-based updating of models in a way that improves the operation of the computer system itself. The integration of heterogeneous data into structured feature vectors, the candidate filtering before generative model invocation, and the emotion-aware relearning of both generative and scoring components result in measurable improvements in processing speed, resource utilization, and accuracy of recommendations compared to naïve implementations or human-only procedures.

Alternative implementations can vary individual components without departing from the technical principles. For example, the schedule grid resolution, the structure of feature vectors, the type of neural network used in the scoring module, and the precise loss functions used during training can be modified. The server may use different emotion analysis engines, different external environment information sources, or different generative AI models. The terminal may be a handheld device, a vehicle-mounted device, or a stationary terminal. In all such cases, the server still integrates schedule information, environment information, preference information, behavior history information, and emotional state information; calculates evaluation indices; generates prompt sentences tailored to a generative AI model; and uses emotion feature values and evaluation information to update internal models, thereby achieving the described technical effects.

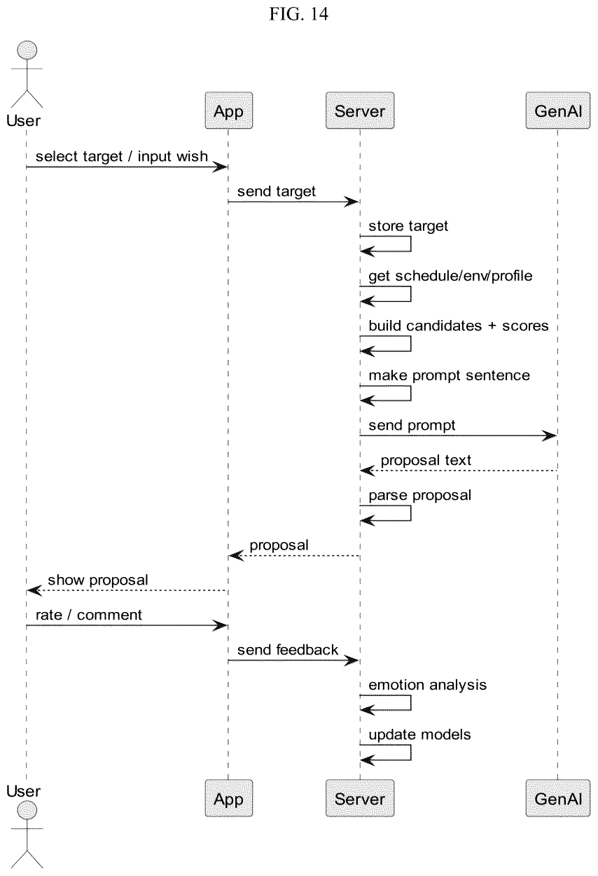

The following describes the processing flow using FIG. 14.

### Step 1:

User operates the terminal to register a desired visit target or service.

User selects a location from a map, selects a category (for example, “park,” “café,” “shopping mall,” or “food delivery”), or enters free text such as “I want to order pizza” or “I want to visit a quiet park.”

Input: User taps and text input on the terminal UI.

Output: Terminal-internal structured data representing a request, for example including a user identifier, a target label, a category label, and, if available, a location identifier.

Terminal converts the raw UI actions into a structured object and assigns a temporary request identifier. Terminal prepares this object for transmission by serializing it into a message format.

### Step 2:

Terminal transmits the visit-target information to the server.

Terminal sends the structured request object through a communication interface to a predefined server endpoint.

Input: Structured request object containing user identifier, category, optional location identifier, and optional free text.

Output: Network message sent to the server, and a local record of the transmission status on the terminal.

Terminal adds authentication data and timestamps, then issues a network request using a reliable transport protocol. Terminal updates a local log so the request can be retried if transmission fails.

### Step 3:

Server receives and stores the visit-target information.

Server parses the incoming message, validates required fields, and normalizes the category and location identifiers.

Input: Network message containing the structured request object.

Output: New records inserted into visit-target tables and a normalized internal representation linked to the user.

Server checks for existing entries for the same location and user, assigns internal unique identifiers, and writes rows into storage including a normalized category code, a geographic coordinate key, and a creation timestamp. Server returns an acknowledgment to the terminal.

### Step 4:

Server acquires schedule information of the user and generates a schedule grid.

Server accesses a schedule management function and retrieves event data for a configurable time range.

Input: User identifier, calendar account reference, and time range.

Output: A schedule grid table in which discrete time slots are labeled as free or occupied.

Server converts event start and end times into slot indices, marks each slot as busy or free, and stores one record per user, date, and slot index. This conversion transforms variable-length events into a fixed-resolution grid, enabling later vectorized calculations.

### Step 5:

Server acquires environment information for relevant locations and times.

Server calls external information providers to obtain weather and congestion data for the user's region and for candidate locations.

Input: Sets of geographic coordinate pairs and time intervals derived from the schedule grid and visit-target information.

Output: Numeric weather features (for example, temperature scores and precipitation penalties) and congestion scores (for example, normalized values from 0 to 1) associated with locations and time slots.

Server maps provider-specific JSON responses into internal numeric attributes, discretizes continuous measurements into intervals aligned with the time slots, and writes the resulting records into environment tables. Server thus produces compact feature vectors for each location-time combination.

### Step 6:

Server aggregates user preference, behavior history, and emotional state information.

Server retrieves statistics on past visits, category preferences, and emotional responses from storage.

Input: User identifier and previously stored feedback, rating, and emotion feature records.

Output: A user profile vector that encodes category preference weights, time-of-day tendencies, environment tolerances, and recent emotional state indicators.

Server computes aggregated statistics such as mean rating per category, typical visit hours, and distributions of emotion labels. Server combines these values into a fixed-length vector and stores or updates a profile entry for the user.

### Step 7:

Server constructs candidate visit times and candidate visit locations.

Server combines the schedule grid with environment information and visit-target information to identify feasible time-location pairs.

Input: Schedule grid, environment feature tables, visit-target records, and user profile vector.

Output: A candidate list containing time slot identifiers, location identifiers, and associated feature vectors for each candidate.

Server filters out time slots that are busy in the schedule grid or that have missing environment data, and associates each remaining time slot with potential locations matching the user's target categories. For each pair, server concatenates time features, location features, environment features, and user profile features into a candidate feature vector.

### Step 8:

Server calculates an evaluation index for each candidate.

Server applies a scoring function to each candidate feature vector.

Input: Candidate feature vectors derived from time, location, environment, and user profile information.

Output: Evaluation index values representing suitability scores for each candidate.

Server executes a parametric model, such as a multilayer neural network or a tree-ensemble model, that outputs a numeric score per candidate. Server performs matrix and vector operations to compute these scores in batches, then writes the scores back into the candidate list structure.

### Step 9:

Server selects high-priority candidates based on the evaluation index.

Server filters and sorts candidates and chooses only those exceeding a threshold or belonging to the top portion of scores.

Input: Candidate list with evaluation index values.

Output: A reduced set of top-ranked candidate time-location pairs to be considered by the generative AI model.

Server sorts candidates in descending order of score, discards those below a predefined cutoff, and caps the number of candidates to a configurable maximum. This selection reduces input size for subsequent processing and enables more efficient resource use.

### Step 10:

Server generates a context-rich prompt sentence for a generative AI model.

Server converts the reduced candidate set and user profile into a structured natural-language instruction.

Input: Top-ranked candidate list, user profile vector, schedule grid summary, environment summaries, and recent emotional state.

Output: A prompt sentence that encodes the relevant constraints, preferences, and context.

Server fills predefined templates with dynamic data. For example, server inserts free time windows, concise descriptions of weather and congestion, and user preference hints into narrative sentences. Server may generate a prompt sentence such as:

“The user wants to order pizza this weekend. The user is free on Saturday from 5 PM to 9 PM and on Sunday from 12 PM to 3 PM. The weather will be sunny on Saturday evening and rainy on Sunday. The restaurant's predicted congestion is low at 6 PM on Saturday and high at 7 PM on Sunday. Based on these conditions and the user's preference for relaxed, not-crowded experiences, propose the best time to order pizza and explain your reasoning.”

Server logs the prompt with an identifier and metadata for later analysis.

### Step 11:

Server transmits the prompt sentence to the generative AI model and obtains a proposal.

Server sends the prompt to a generative AI model via a model-serving interface and receives generated text.

Input: Prompt sentence and generation parameters such as maximum output length and sampling temperature.

Output: Generated response text containing proposal content and explanation.

Server establishes a secure connection to the model endpoint, transmits the prompt and parameters, and waits for the model's token sequence output. Server concatenates tokens into a response string and validates basic structural requirements, such as the presence of at least one time and location reference.

### Step 12:

Server parses the generated response into structured proposal results.

Server analyzes the text to extract recommended times, locations, and explanation segments.

Input: Generated response text from the generative AI model.

Output: One or more structured proposal records including selected candidate identifiers and associated explanation strings.

Server uses parsing rules or markers hinted in the prompt to locate time expressions and location names. Server maps these expressions back to candidate identifiers by matching times and locations against the candidate list. Server constructs proposal records linking user identifiers, candidate identifiers, and explanations, and stores them in recommendation tables.

### Step 13:

Server sends proposal results to the terminal for presentation to the user.

Server prepares a compact response including key proposal fields and explanations.

Input: Structured proposal records (times, locations, explanations) associated with the user.

Output: Network response message sent to the terminal containing the proposal results.

Server selects a limited number of proposals (for example, top one or top three), formats them into a message payload, and transmits the payload to the terminal. Server may include identifiers so that subsequent user feedback can be linked to specific proposals.

### Step 14:

Terminal displays the received proposals to the user.

Terminal renders recommendation items using text and graphical elements.

Input: Network response message with proposal results, including times, locations, and explanations.

Output: Visual interface elements shown on the terminal display, and event hooks for user actions such as accept, reject, or rate.

Terminal converts times into local display formats, displays location names and optional maps, and shows explanation text. Terminal creates interactive controls so the user can respond to each proposal.

### Step 15:

User evaluates the proposal and provides feedback.

User may select a proposal, reject it, rate it, or write a comment about the recommendation or a subsequent visit.

Input: Proposal view on the terminal and UI controls for rating and commenting.

Output: Feedback data on the terminal, including chosen actions, rating values, and comment text.

User taps rating controls (for example, stars), types comments such as “The café was quiet and relaxing,” or indicates that a suggested time was not convenient. The terminal compiles these inputs into a structured feedback object.

### Step 16:

Terminal transmits evaluation information and feedback information to the server.

Terminal sends the compiled feedback to the server for analysis.

Input: Feedback object including proposal identifier, user identifier, rating, and comment text.

Output: Network message containing feedback transmitted to the server and confirmation state stored on the terminal.

Terminal attaches timestamps and device identifiers, serializes the feedback, and issues a request to a feedback endpoint on the server. Terminal records that the feedback has been sent so it is not duplicated.

### Step 17:

Server stores feedback and performs emotion analysis processing.

Server inserts the feedback into storage and derives emotion feature values from the user's comment.

Input: Feedback object containing rating and comment text, optionally linked to visit data.

Output: Database records in feedback tables and emotion feature values stored in emotion tables.

Server writes feedback entries including references to the proposal and candidate identifiers.

Server processes the comment text using an emotion analysis function that tokenizes the text, generates embeddings, and applies a classifier to determine sentiment score and emotion categories. Server stores these derived values as emotion feature vectors.

### Step 18:

Server updates user profiles and training datasets based on new feedback.

Server enriches the user's preference and emotion profile with the latest experience.

Input: Feedback records and associated emotion feature values.

Output: Updated user profile vector and expanded datasets for training the evaluation index model and optionally fine-tuning the generative AI model.

Server recalculates statistics such as average satisfaction per category and updates category weightings in the user profile. Server adds new data points to training buffers that relate context features, prompt identifiers, and realized outcomes to satisfaction measures.

### Step 19:

Server adjusts parameters used in evaluation index calculation.

Server retrains or fine-tunes the scoring model to better align scores with observed satisfaction.

Input: Training dataset comprising candidate feature vectors, realized satisfaction labels, and emotion feature values.

Output: Updated scoring model parameters stored in the storage device.

Server defines a loss function, such as mean squared error or ranking loss, and performs optimization iterations where gradients are computed and weights are updated. Server then replaces older parameter sets with newly optimized parameters, which affects future evaluation index computations.

### Step 20:

Server optionally fine-tunes the generative AI interaction strategy using accumulated logs.

Server updates prompt-generation rules and, where feasible, fine-tunes parts of the generative AI model or associated selection policies.

Input: Logs of prompt sentences, generated responses, user outcomes, and emotion feature values.

Output: Refined prompt templates, updated selection thresholds, and possibly adjusted generative AI behavior through external configuration or fine-tuning.

Server analyzes correlations between prompt structures and user satisfaction, then modifies template rules, such as emphasizing congestion information for certain users or simplifying prompts when unnecessary details do not improve results. When supported, server sends curated prompt-response pairs and outcome labels to a model-training interface to fine-tune the generative AI model or to adjust a policy layer controlling post-processing.

### Step 21:

Server applies updated models and rules in subsequent recommendation cycles.

Server uses the revised evaluation index model and prompt-generation logic for future user requests.

Input: New visit-target information, updated user profiles, refined model parameters, and environment data.

Output: Improved candidate selection, more efficient prompt sentences, and higher-quality proposal results.

Server executes the same flow as in earlier steps, but with updated weights and template rules, thereby producing proposals that are better aligned with the user's evolving preferences and emotional needs, while consuming fewer computational and network resources.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like.

The data generation model 58 is obtained by performing deep learning with a neural network.

The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

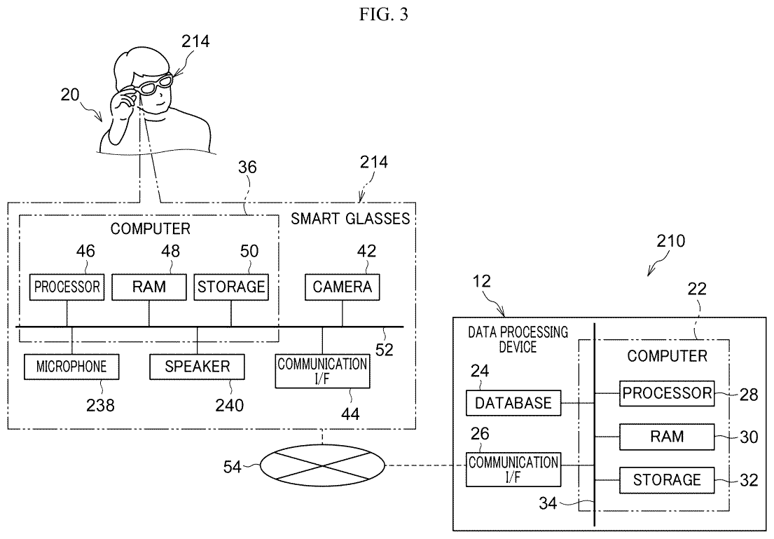

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

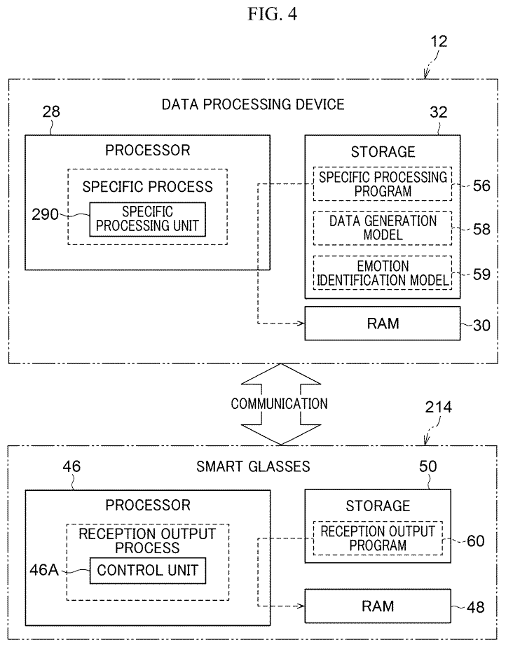

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

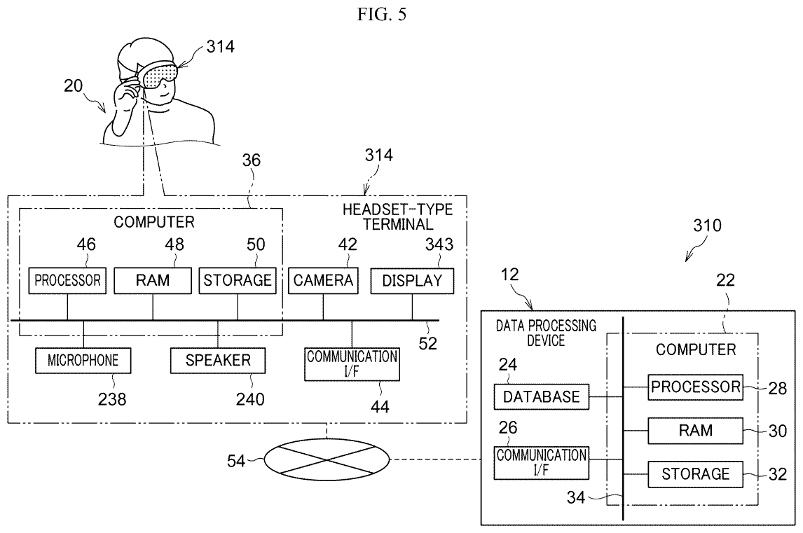

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

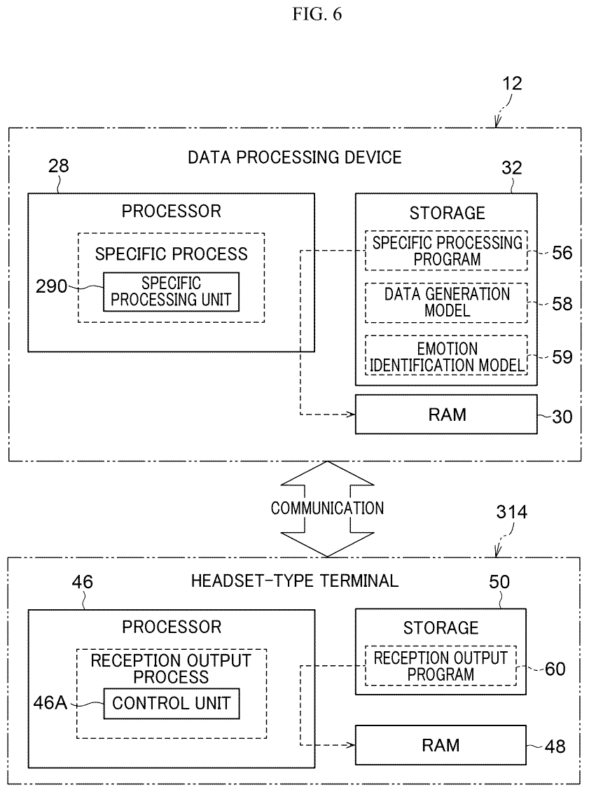

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

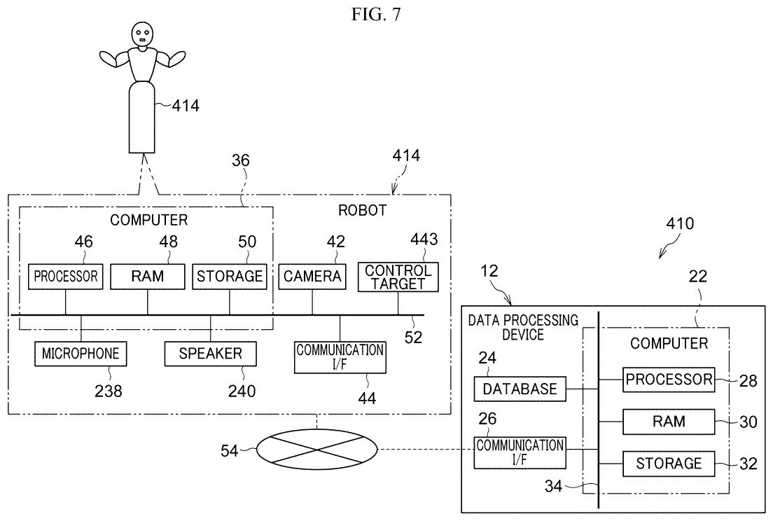

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

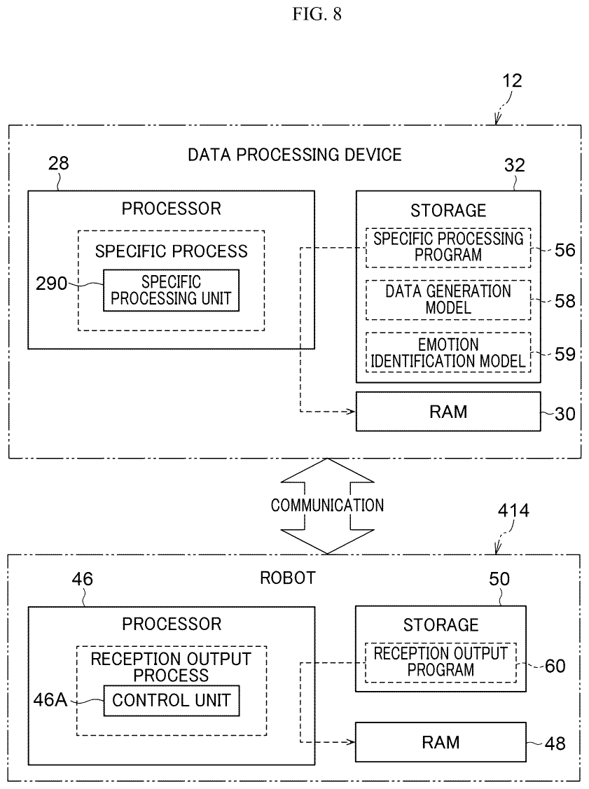

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

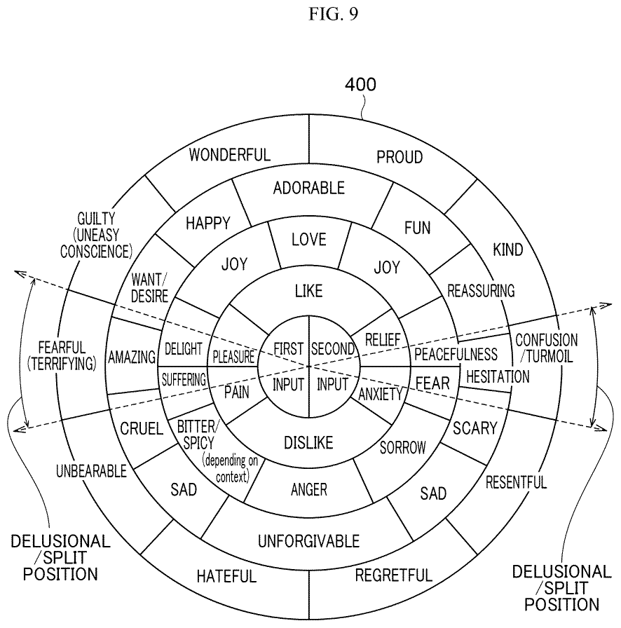

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

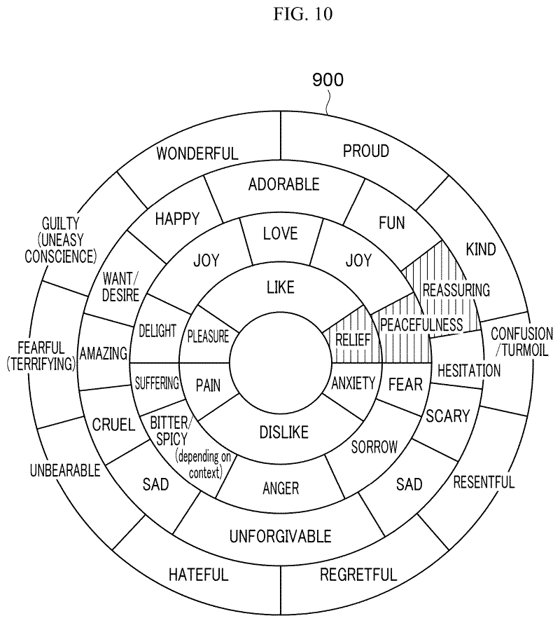

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire information indicating locations that a user desires to visit, and store and manage the information in a storage device,
acquire time-availability information of the user by cooperating with a schedule-management application, extract time slots during which the user is available, and store the extracted time slots in the storage device,
acquire weather information corresponding to the locations that the user desires to visit and to the time slots during which the user is available from an external information providing device, and store the acquired weather information in the storage device in association with combinations of the locations and the time slots,
acquire congestion information corresponding to the locations that the user desires to visit and to the time slots during which the user is available from an external information providing device, and store the acquired congestion information in the storage device in association with combinations of the locations and the time slots,
calculate, based on information stored in the storage device including the information indicating the locations that the user desires to visit, the time slots during which the user is available, the weather information, and the congestion information, an evaluation value for each combination of a location and a time slot, and select visit candidates based on the calculated evaluation values,
generate, using structured data including the selected visit candidates and selection reasons corresponding to the selected visit candidates, a prompt sentence for causing a generative information processing apparatus to generate a natural-language recommendation sentence that explains or recommends the visit candidates, and input the prompt sentence to the generative information processing apparatus,
present, via an output device, the recommendation sentence output from the generative information processing apparatus, acquire evaluation information of the user regarding the presented recommendation sentence and the visit candidates, and store the acquired evaluation information in the storage device, and
analyze the acquired evaluation information in association with the weather information, the congestion information, the time slots, and attribute information regarding the locations, and update, based on a result of the analysis, weighting coefficients or evaluation parameters used when calculating the evaluation values, thereby adjusting selection processing of visit candidates for subsequent proposals to be adapted to an individual user.

### Supplementary 2

The system according to supplementary 1,
wherein the processor is configured to
acquire a history indicating that the user has designated locations that the user desires to visit in an information-sharing application, via an information-acquisition interface provided by an information-sharing service, extract, from the acquired history, information indicating the locations that the user desires to visit, and store the extracted information in the storage device.

### Supplementary 3

The system according to supplementary 1,
wherein the processor is configured to
generate the prompt sentence by converting data including locations serving as the visit candidates, visit date-and-time information corresponding to the locations, the weather information and the congestion information at the visit date and time, and preference information of the user estimated based on the evaluation information, into a description format that causes the generative information processing apparatus to generate a visit plan expressed in natural language.

### Application Example 1

### Supplementary 1

A system comprising a processor and a non-transitory storage device,
wherein the processor is configured to
acquire information regarding a facility or location that a user desires to visit, and register the information as structured data stored in the non-transitory storage device,
acquire behavioral schedule information of the user by cooperating with a schedule management application or a schedule management service, and calculate time periods in which the user is available for visiting based on the behavioral schedule information,
acquire weather information for a predetermined geographic area via an external information providing service, and extract time periods that satisfy visit-appropriate weather conditions based on the weather information,
acquire congestion state information regarding the facility or location via an external information providing service, and extract time periods in which a congestion degree is below a predetermined threshold based on the congestion state information,
integrate, based on time information, the time periods in which the user is available for visiting, the time periods that satisfy the visit-appropriate weather conditions, and the time periods in which the congestion degree is below the predetermined threshold, and identify, by computation, candidate visit time periods in which the time periods overlap,
read preference information of the user and past visit history information from the non-transitory storage device, and generate a prompt sentence to be input to a generative artificial intelligence model by combining the candidate visit time periods with the preference information and the past visit history information,
input the prompt sentence to the generative artificial intelligence model and acquire, from the generative artificial intelligence model, a proposal result including a recommended visit time period for the facility or location and a reason for the recommendation, and
transmit the proposal result to a user terminal, acquire acceptance information or modification information from the user terminal, record the acceptance information or the modification information as the past visit history information in the non-transitory storage device, and reflect the past visit history information in at least one of generation of a subsequent prompt sentence and identification of a subsequent candidate visit time period.

### Supplementary 2

The system according to supplementary 1,
wherein the processor is configured to acquire the information regarding the facility or location that the user desires to visit via a communication interface of a position information providing service or an information sharing service, and store the acquired information as the structured data in the non-transitory storage device.

### Supplementary 3

The system according to supplementary 1,
wherein the processor is configured to generate the prompt sentence by describing, in a natural language format or a structured text format analyzable by the generative artificial intelligence model, at least time-series information and attribute information including the behavioral schedule information of the user, the weather information, the congestion state information, the candidate visit time periods, the preference information, and the past visit history information, thereby instructing the generative artificial intelligence model to generate an optimal visit plan.

### Example 2

### Supplementary 1

A system comprising a processor,
wherein the processor is configured to
acquire information on target locations that a user desires to visit via a communication function of an external information sharing service, and store extracted location attributes in a general-purpose storage device, and
acquire schedule information of the user via a communication function of an external schedule management service, and calculate free time periods within a predetermined period based on time information, and
acquire weather information and occupant number information associated with the free time periods and the target locations via a communication function of an external information providing service, and calculate a visit suitability score for each target location by quantifying the visit suitability based on the weather information and the occupant number information, and
select visit candidate locations and visit candidate time periods based on the visit suitability score and preference information of the user, and generate a prompt sentence including an explanation text of the selection result, past evaluation information of the user, and
information on preference tendencies of the user, and configure the prompt sentence as input data to a generative artificial intelligence model, and
input the prompt sentence to the generative artificial intelligence model, obtain a response message from the generative artificial intelligence model, and extract and store a visit proposal message to be presented to the user from the response message, and
notify a terminal device of the visit proposal message, and
acquire evaluation information and feedback information of the user regarding the visit proposal message, the evaluation information and the feedback information being input from the terminal device, and update a calculation rule of the visit suitability score and a generation condition of the prompt sentence based on the evaluation information and the feedback information, and adjust input content to the generative artificial intelligence model so that a next prompt sentence is generated using the updated generation condition.

### Supplementary 2

The system according to supplementary 1,
wherein the processor is configured to
acquire the information on the target locations that the user desires to visit by using an application programming interface of the external information sharing service, and extract a location name, position coordinates, and classification information from structured data acquired via the application programming interface, and store the location name, the position coordinates, and the classification information in the general-purpose storage device.

### Supplementary 3

The system according to supplementary 1,
wherein the processor is configured to
integrate the schedule information of the user, the weather information, the occupant number information, and the past evaluation information of the user, extract a plurality of the visit candidate locations and the visit candidate time periods, generate explanation text data including reasoning information for each extracted result, and input a prompt sentence including the explanation text data to the generative artificial intelligence model to instruct the generative artificial intelligence model to generate a proposal message related to an optimal visit plan.

### Application Example 2

### Supplementary 1

A system comprising a processor, and a storage device and an output device operatively coupled to the processor,
wherein the processor is configured to
store, in the storage device, visit-target information indicating a location that a user wishes to visit,
acquire schedule information of the user by synchronizing with a schedule management function,
acquire, from an external information providing function, environment information including weather information and congestion information,
integrate the schedule information, the weather information, and the congestion information to generate candidate visit times and candidate visit locations,
acquire, from the storage device, preference information of the user, past behavior history information of the user, and emotional state information of the user, and calculate an evaluation index by associating the preference information, the past behavior history information, and the emotional state information with the candidate visit times and the candidate visit locations,
generate a prompt sentence for instructing a generative AI model to generate a proposal content, the prompt sentence being generated on a basis of the integrated information and the evaluation index,
input the prompt sentence to the generative AI model and acquire, from the generative AI model, a proposal result and explanation information relating to at least one of the candidate visit times and the candidate visit locations,
present the proposal result to a user terminal via the output device,
acquire, from the user terminal, evaluation information and feedback information from the user regarding the proposal result, and perform emotion analysis processing on the evaluation information and the feedback information to extract emotion feature values, and
perform, on a basis of the emotion feature values and the evaluation information, a relearning process for the generative AI model and a parameter updating process for calculation of the evaluation index, so as to improve a next proposal content.

### Supplementary 2

The system according to supplementary 1,
wherein the processor is configured to
acquire, as at least part of the visit-target information, location information that has been marked as a desired visit by the user via an information sharing function interface, and store the location information in the storage device.

### Supplementary 3

The system according to supplementary 1,
wherein the processor is configured to
acquire, as the emotional state information of the user, at least one of text information, voice information, and image information, estimate an emotional state of the user by an emotion analysis function, and dynamically change at least one of a content of the prompt sentence and priorities of the candidate visit times and the candidate visit locations in accordance with the emotional state.

What is claimed is:

1. A system comprising:
a communication interface coupled to a packet-switched network;
a storage device; and
circuitry configured to:
acquire, via the communication interface, location preference data indicating locations of interest to a user, and store the location preference data in the storage device;
acquire temporal availability data of the user by cooperating with a schedule management application, extract available time slot data, and store the available time slot data in the storage device;
acquire, from an external information provision apparatus via the communication interface, environmental condition data and congestion index data corresponding to combinations of the location preference data and the available time slot data, and store the environmental condition data and the congestion index data in association with the combinations in the storage device;
compute an evaluation value for each combination of a location and a time slot based on the location preference data, the available time slot data, the environmental condition data, and the congestion index data, and select candidate data records based on the computed evaluation values;
generate a prompt sentence by converting structured data comprising the selected candidate data records and selection rationale data into an instruction format for a generative neural network model, input the prompt sentence to the generative neural network model, and acquire a recommendation output from the generative neural network model; and
acquire evaluation data from the user regarding the recommendation output, store the evaluation data in the storage device, and update weighting coefficients used in computing the evaluation values based on the evaluation data.

2. The system according to claim 1, wherein the circuitry is further configured to:
acquire the location preference data via an application programming interface of an external information sharing platform, parse structured content data from the external information sharing platform, and store the parsed content data in the storage device as the location preference data.

3. The system according to claim 2, wherein the circuitry extracts from the parsed content data at least location identifiers, descriptive text data, and associated attribute tags, and stores the extracted data in normalized relational tables in the storage device.

4. The system according to claim 3, wherein the circuitry computes a relevance score for each location identifier based on a frequency of appearance in the parsed content data and a recency weighting factor derived from temporal metadata of the content data.

5. The system according to claim 1, wherein the evaluation value is computed by combining a temporal suitability factor based on the available time slot data, an environmental favorability factor based on the environmental condition data, a congestion penalty factor inversely proportional to the congestion index data, and a user preference factor derived from the evaluation data accumulated in the storage device.

6. The system according to claim 5, wherein the circuitry applies a non-linear weighting formula to combine the temporal suitability factor, the environmental favorability factor, the congestion penalty factor, and the user preference factor, and the weighting coefficients of the non-linear weighting formula are adjusted based on a regression analysis of the evaluation data.

7. The system according to claim 6, wherein the circuitry re-ranks the candidate data records after each acquisition of evaluation data by recomputing the evaluation values with updated weighting coefficients, and stores a history of weighting coefficient values in the storage device for trend analysis.

8. The system according to claim 1, wherein the circuitry is further configured to:
generate the prompt sentence by combining a template data structure with the selected candidate data records, the environmental condition data, and user attribute data, wherein the template data structure specifies a structured instruction format indicating a desired output schema for the generative neural network model.

9. The system according to claim 8, wherein the circuitry includes in the prompt sentence a summary of historical evaluation data comprising accepted and rejected recommendations and associated contextual parameters, enabling the generative neural network model to condition its output on the historical evaluation data.

10. The system according to claim 9, wherein the circuitry parses the recommendation output from the generative neural network model to extract structured recommendation records comprising location identifiers, recommended time slots, and explanatory text, and validates each location identifier against the location preference data in the storage device.

11. The system according to claim 1, wherein the circuitry is further configured to:
generate a sequential plan data structure comprising a time-ordered sequence of the selected candidate data records, compute a transition cost between consecutive candidates based on distance data and transit time data, and include the sequential plan data structure and the transition costs in the prompt sentence.

12. The system according to claim 11, wherein the circuitry acquires real-time transit data from an external transportation information apparatus via the communication interface, and dynamically adjusts the transition costs based on the real-time transit data.

13. The system according to claim 12, wherein the circuitry generates navigation instruction data for transitions between consecutive candidates in the sequential plan data structure and transmits the navigation instruction data to the terminal device via the communication interface.

14. The system according to claim 1, wherein the circuitry is further configured to:
train an anomaly detection model on the evaluation data representing normal user preference patterns, compute a reconstruction error for newly received evaluation data, and generate a recalibration trigger when the reconstruction error exceeds a predetermined threshold, the recalibration trigger causing the circuitry to reset the weighting coefficients to default values and initiate a relearning phase.

15. The system according to claim 14, wherein the circuitry, upon the recalibration trigger, generates a diagnostic prompt sentence for the generative neural network model requesting an analysis of detected preference shift patterns based on a comparison of recent evaluation data and historical evaluation data.

16. The system according to claim 1, wherein the circuitry is further configured to:
perform fine-tuning of the generative neural network model by generating training data pairs comprising prompt sentences and corresponding user-evaluated recommendation outputs, and updating model parameters of the generative neural network model based on the training data pairs.

17. The system according to claim 1, wherein the circuitry acquires the environmental condition data comprising at least temperature data, precipitation probability data, and wind speed data from a meteorological information service via the communication interface, and normalizes the environmental condition data to a common numerical scale prior to computing the evaluation value.

18. A system comprising:
a communication interface coupled to a packet-switched network;
a storage device; and
circuitry configured to:
acquire, via the communication interface, location preference data from an external information sharing platform and store the location preference data comprising location identifiers and attribute tags in the storage device;
acquire temporal availability data of a user from a schedule management application, and acquire environmental condition data and congestion index data from an external information provision apparatus, and store the temporal availability data, the environmental condition data, and the congestion index data in association with combinations of location identifiers and time slots in the storage device;
compute an evaluation value for each combination by applying a non-linear weighting formula combining a temporal suitability factor, an environmental favorability factor, a congestion penalty factor, and a user preference factor, and select candidate data records having evaluation values exceeding a selection threshold;
generate a prompt sentence comprising the selected candidate data records, selection rationale data, the environmental condition data, and historical evaluation data, input the prompt sentence to a generative neural network model, and acquire a recommendation output comprising structured recommendation records;
transmit, via the communication interface, the recommendation output to a terminal device of the user; and
acquire evaluation data from the terminal device, store the evaluation data in the storage device, and update the weighting coefficients of the non-linear weighting formula based on the evaluation data to adjust selection processing for subsequent proposals.

19. The system according to claim 18, wherein the circuitry generates a sequential plan data structure comprising a time-ordered sequence of the selected candidate data records, computes transition costs between consecutive candidates based on distance data and real-time transit data, and includes the sequential plan data structure in the prompt sentence.

20. A method comprising:
acquiring, via a communication interface coupled to a packet-switched network, location preference data indicating locations of interest to a user, and storing the location preference data in a storage device;
acquiring temporal availability data of the user by cooperating with a schedule management application, extracting available time slot data, and storing the available time slot data in the storage device;
acquiring, from an external information provision apparatus via the communication interface, environmental condition data and congestion index data corresponding to combinations of the location preference data and the available time slot data, and storing the environmental condition data and the congestion index data in association with the combinations in the storage device;
computing an evaluation value for each combination of a location and a time slot based on the location preference data, the available time slot data, the environmental condition data, and the congestion index data, and selecting candidate data records based on the computed evaluation values;
generating a prompt sentence by converting structured data comprising the selected candidate data records and selection rationale data into an instruction format for a generative neural network model, inputting the prompt sentence to the generative neural network model, and acquiring a recommendation output from the generative neural network model; and
acquiring evaluation data from the user regarding the recommendation output, storing the evaluation data in the storage device, and updating weighting coefficients used in computing the evaluation values based on the evaluation data.
